(19) United States
(12) Patent Application Publication
(10) Pub. No.: US 2026/0042469 A1
(43) Pub. Date: Feb. 12, 2026

(54) REAL-TIME IDENTIFICATION OF VEHICLE FEATURES FOR ADAPTIVE BEHAVIOR IN SELF-DRIVING VEHICLES

(71) Applicant: Volvo Car Corporation, Göteborg (SE)

(72) Inventors: Ali NOURI, Göteborg (SE); Zhennan FEI, Göteborg (SE)

(73) Assignee: Volvo Car Corporation, Göteborg (SE)

(21) Appl. No.: 18/800,349

(22) Filed: Aug. 12, 2024

(51) Int. Cl. B60W 60/00; B60W 30/16; B60W 50/00; G06V 20/58; G06V 20/62

(52) U.S. Cl. CPC B60W 60/00274; B60W 30/16; B60W 60/00276; G06V 20/58; G06V 20/625; B60W 2050/0014; B60W 2554/402; B60W 2554/4049; B60W 2720/103; B60W 2754/10

(57) ABSTRACT

According to an embodiment, disclosed is a system comprising, a sensor and a processor; wherein the processor storing instructions in a non-transitory memory that, when executed, cause the processor to detect, via the sensor of a host vehicle, a target vehicle; capture, via the sensor, a first region comprising a first characteristic of the target vehicle; analyze, the first region using an image processing module; determine, an identity of the target vehicle; capture, via the sensor, a second region comprising a second characteristic of the target vehicle; analyze, the second region using the image processing module; and determine, a safety feature that is enabled in the target vehicle.

### FIELD OF THE INVENTION

The disclosure relates to vehicle control systems and, more specifically, to vehicle control systems for adaptive behavior in self-driving vehicles based on real-time vehicle identification, its features, and a predicted behavior, characteristics, or capability of neighboring vehicles.

### BACKGROUND

Autonomous vehicles (AVs) need to drive cautiously to avoid being exposed to hazardous situations. For instance, AVs need to reduce the speed or adapt the trajectory both longitudinally and/or laterally, if there is possibility that another vehicle enters into the future trajectory of the host vehicle.

Therefore, there is a need for a system for determining what other vehicles/surrounding vehicles are capable of, for planning the host vehicle's trajectory.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, disclosed is a system comprising, a sensor and a processor; wherein the processor storing instructions in a non-transitory memory that, when executed, cause the processor to: detect, via the sensor of a host vehicle, a target vehicle; capture, via the sensor, a first region comprising a first characteristic of the target vehicle; analyze, the first region using an image processing module; determine, an identity of the target vehicle; capture, via the sensor, a second region comprising a second characteristic of the target vehicle; analyze, the second region using the image processing module; and determine, a safety feature that is enabled in the target vehicle; and wherein the system is configured for real-time identification of the safety feature in the target vehicle for adaptive behavior of the host vehicle.

According to an embodiment, disclosed is a method comprising, detecting, via a sensor of a host vehicle, a target vehicle; capturing, via the sensor, a first region comprising a first characteristic of the target vehicle; analyzing, the first region using an image processing module; determining, an identity of the target vehicle; capturing, via the sensor, a second region comprising a second characteristic of the target vehicle; analyzing, the second region using the image processing module; and determining, a safety feature that is enabled in the target vehicle; and wherein the method is configured for real-time identification of the safety feature in the target vehicle for adaptive behavior of the host vehicle.

According to an embodiment, disclosed is a non-transitory computer-readable medium having stored thereon instructions executable by a computer system to perform operations comprising: detecting, via a sensor of a host vehicle, a target vehicle; capturing, via the sensor, a first region comprising a first characteristic of the target vehicle; analyzing, the first region using an image processing module; determining, an identity of the target vehicle; capturing, via the sensor, a second region comprising a second characteristic of the target vehicle; analyzing, the second region using the image processing module; and determining, a safety feature that is enabled in the target vehicle; and wherein the instructions are configured for real-time identification of the safety feature in the target vehicle for adaptive behavior of the host vehicle.

According to an embodiment, disclosed is a system comprising, a sensor, a communication module, and a processor; wherein the processor storing instructions in a non-transitory memory that, when executed, cause the processor to detect, via the sensor of a host vehicle, a target vehicle; establish a connection, via the communication module, between the host vehicle and the target vehicle; and receive, via the communication module, a first set of safety features enabled in the target vehicle; wherein the system is configured for real-time identification of the safety feature in the target vehicle for adaptive behavior of the host vehicle.

### BRIEF DESCRIPTION OF THE FIGURES

These and other aspects of the present invention will now be described in more detail, with reference to the appended drawings showing exemplary embodiments of the present invention, in which:

FIG. 1A shows an autonomous vehicle along with other agents on a path according to an embodiment.

FIG. 1B shows an autonomous vehicle's predicted trajectory and safe distances according to an embodiment.

FIG. 2 shows a block diagram of the system for real-time vehicle identification for adaptive behavior in self-driving vehicles according to an embodiment.

FIG. 3 is an illustration of a vehicle with various sensors, actuators, and systems according to an embodiment.

FIG. 4 shows a block diagram of electronic components of a vehicle according to an embodiment.

FIG. 5A shows a flow chart for detecting a brand using image processing according to an embodiment.

FIG. 5B shows an image processing module capturing and analyzing the image with a brand name and/or brand characteristic design feature for brand detection according to an embodiment.

FIG. 5C shows an image processing module capturing and analyzing the image with a brand name and/or brand characteristic design feature for brand detection according to an embodiment.

FIG. 5D shows an image processing module capturing and analyzing the image with a brand name and/or brand characteristic design feature for brand detection according to an embodiment.

FIG. 5E shows an image processing module capturing and analyzing the image with a brand name and/or license plate for brand detection according to an embodiment.

FIG. 5F shows the sensing of surroundings from the vision system of the autonomous driving vehicle for brand detection according to an embodiment.

FIG. 6A shows a method for brand recognition using vehicle features/characteristics according to an embodiment.

FIG. 6B shows a flowchart for detecting the brand of a target vehicle and behavior planning of the host vehicle using a machine learning model according to an embodiment.

FIG. 6C shows an example block diagram for brand detection and behavior planning using a machine learning model according to an embodiment.

FIG. 6D shows a structure of the neural network/machine learning model with a feedback loop according to an embodiment.

FIG. 6E shows a structure of the neural network/machine learning model with reinforcement learning according to an embodiment.

FIG. 7A shows a visual indicator for Blind Spot Information System (BLIS) according to an embodiment.

FIG. 7B shows a vision system of autonomous vehicles according to an embodiment.

FIG. 7C shows a display of advanced safety features that are enabled in autonomous vehicles on an instrument cluster according to an embodiment.

FIG. 7D shows the adapted behavior of the host vehicle after considering the target vehicle's capabilities according to an embodiment.

FIG. 8 shows communication between a host vehicle and a target vehicle according to an embodiment.

FIG. 9A shows an example message transmitted by the host vehicle to the target vehicle according to an embodiment.

FIG. 9B shows an example message received by the target vehicle from the host vehicle according to an embodiment.

FIG. 9C shows an example message on cybersecurity alert on the target vehicle raised by the host vehicle according to an embodiment.

FIG. 10A shows the block diagram of the cyber security module in view of the system and server according to an embodiment.

FIG. 10B shows a block diagram of the cyber security module configured for checking a cybersecurity threat according to an embodiment.

FIG. 10C shows a block diagram of the cyber security module configured for checking a cybersecurity threat according to an embodiment.

FIG. 11A shows a block diagram of the method executed by the vehicle for real-time vehicle identification for adaptive behavior in self-driving vehicles according to an embodiment.

FIG. 11B shows a block diagram of the system of a vehicle for real-time vehicle identification for adaptive behavior in self-driving vehicles according to an embodiment.

FIG. 11C shows a block diagram of the method executed by the non-transitory computer-readable medium for real-time vehicle identification for adaptive behavior in self-driving vehicles according to an embodiment.

FIG. 12 shows a block diagram of the system of vehicle for real-time vehicle identification for adaptive behavior in self-driving vehicles according to an embodiment.

FIG. 13A shows a block diagram of the method of vehicle for real-time vehicle identification for adaptive behavior in self-driving vehicles according to an embodiment.

FIG. 13B shows a block diagram of the system of a vehicle for real-time vehicle identification for adaptive behavior in self-driving vehicles according to an embodiment.

FIG. 13C shows a block diagram of the method executed by the non-transitory computer-readable medium for a vehicle for real-time vehicle identification for adaptive behavior in self-driving vehicles according to an embodiment.

FIG. 14A shows a block diagram of the method 1400 executed by the vehicle for determining a safety feature enabled in a vehicle according to an embodiment.

FIG. 14B shows a block diagram of the system of vehicle for determining a safety feature enabled in a vehicle according to an embodiment.

FIG. 14C shows a block diagram of the method executed by the non-transitory computer-readable medium for determining a safety feature enabled in a vehicle according to an embodiment.

FIG. 15 shows a block diagram of the system of vehicle for determining a safety feature enabled in a vehicle according to an embodiment.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning “ refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses etc. are examples of vehicles.

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module” (ECM), is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. Driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

As used herein, the term “advanced features,” refers to any feature which might affect the driving behavior of the driver or autonomous driving function. The function might not directly affect or avoid some behaviors, but they would at least have an effect on drivers to change the driving behavior.

As used herein, the term “vehicle capability” refers to a set of functions and performance characteristics that a vehicle possesses, which enable it to respond to and handle various driving situations. For example, these capabilities may be related to safety, navigation, communication, and overall vehicle performance.

As used herein, the term “host vehicle” refers to a vehicle in a given scenario, typically an autonomous or semi-autonomous vehicle, that is actively monitoring and interacting with its surroundings. It is also referred to as an ego vehicle.

As used herein, the term “target vehicle” refers to any vehicle that is being monitored, tracked, or being interacted with by the host vehicle in a given scenario.

As used herein, the term “characteristic of a vehicle” refers to specific attributes, features, or behaviors that define and differentiate one vehicle from another. These characteristics may be physical, functional, or performance-related, and they play a role in vehicle identification, safety assessments, and autonomous driving systems. For example, the brand and model of a vehicle, such as a Volvo XC90 or a Tesla Model S, are characteristics which indicate the manufacturer and the specific type of vehicle.

As used herein, the term “identity of a vehicle” refers to a unique set of attributes and information that distinguish one vehicle from another. This identity is used to determine and distinguish one vehicle from another to make and base the decisions. For example, the identity of a vehicle could be Volvo XC90 based on its identified characteristic.

As used herein, the term “confidence level” refers to the degree of certainty or assurance about the accuracy and reliability of detected/determined information and/or system performance related to the vehicle. For example, a high confidence level in the autonomous system implies that it can reliably perform tasks such as lane changes, merging, and emergency braking under various conditions.

As used herein, the term “behavior” refers to the actions and responses of a vehicle in various driving situations, which can be influenced by the driver's inputs, the vehicle's automated systems, or a combination of both. For example, it may encompass a wide range of activities and vehicle characteristics, including acceleration, braking, turning, lane changing, following distance, coordinated behavior with other vehicles, and reaction to traffic signals and other road users.

As used herein, the term “adaptive behavior” in the context of vehicles refers to the ability of a vehicle to adjust its actions and responses dynamically based on real-time environmental inputs, nearby vehicle capabilities, and situational changes.

As used herein, the term “scenario” in the context of vehicles and autonomous driving refers to a specific set of conditions and events that describe a particular situation on the road. It involves the interaction between various elements such as vehicles, pedestrians, road infrastructure, and environmental conditions. Scenarios are used to simulate, analyze, and evaluate the behavior and performance of vehicles.

As used herein the term “camera-based sensors” refers to sensors that utilize cameras as their primary sensing modality. These sensors incorporate camera technology to capture visual data, which is then processed and analyzed to extract relevant information. Camera-based sensors may further include additional components or functionalities beyond basic image capture, such as depth sensing, infrared imaging, or multispectral imaging. Camera-based sensors may encompass a variety of camera configurations and features tailored to specific monitoring tasks, such as driver monitoring, user detection, object recognition, and/or gesture recognition.

The term “virtual lasso” in the context of autonomous driving, may refer to a conceptual tool or technique used in the software algorithms governing the behavior of self-driving vehicles. Virtual lasso refers to a software feature or algorithm designed to define and manage specific areas or boundaries around the vehicle or certain objects within its environment. This virtual boundary plays is used in various aspects of autonomous driving, including object detection and tracking, safety zone creation, and enhanced navigation. By encircling or defining the perimeter around objects of interest, such as pedestrians, other vehicles, or obstacles, the virtual lasso allows the autonomous system to monitor these objects continuously, predict their movements, and adjust the vehicle's path accordingly.

The term “vehicle system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being on cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

Autonomous vehicles must prioritize safety in all driving situations. Autonomous vehicles should drive defensively. Autonomous vehicles should prioritize risk aversion. Host vehicle could be autonomous vehicles according to an embodiment. Normally when the host vehicle wants to do path planning during activation of autonomous vehicles, there are other agents, i.e., other surrounding vehicles as well on the road. Each of those agents have different behaviors, like some turn left, some turn right, some change the lane, some stay in the lane, some stop, some reduce the speed, some increase the speed, and the like. Further, to add to various driving behaviors, every individual has their unique driving preferences. Some vehicles exhibit a more aggressive behavior, perhaps evident in their design or construction features. Others prioritize safety, opting for less speed or less aggressive braking and/or acceleration profiles. Essentially, each vehicles' behavior varies, i.e., behavior of each agent is different.

In an embodiment, to know what kind of function each of these vehicles have, one has to predict their movements. For example, Volvo® cars have blind spot detection to warn the driver, when there is a vehicle in the adjacent lane, not to change lanes. The system may not prevent but warn the driver. Some of the vehicles may have warning systems that can be more trusted than the vehicles that do not have this feature, on the assumption that the driver is a rational driver. The second assumption is that, when the target vehicle is warning its driver, the host vehicle in the lane can be sure that the target vehicle will not move into the adjacent lane. So maybe the host vehicle can change its behavior to go a bit faster or drive at a maximum safe speed. On the other hand, if the target vehicles have random lane changes which do not have such an advanced system, maybe the host vehicle changes its behavior to be more cautious and may reduce the speed to evade the problem.

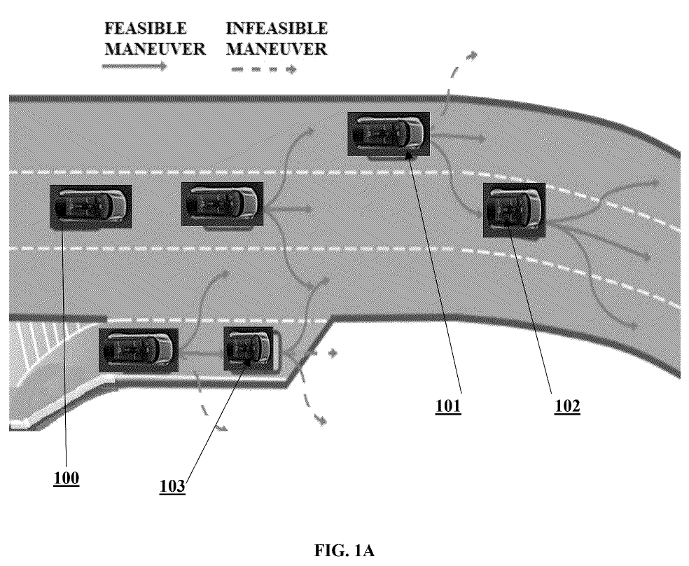

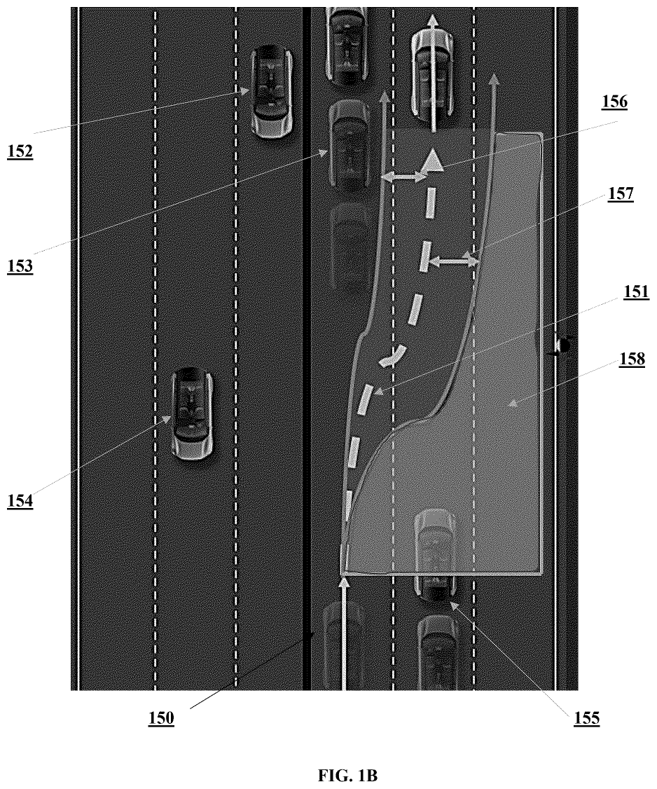

FIG. 1A shows an autonomous vehicle along with other agents on a path according to an embodiment. To ensure safe path planning, autonomous vehicles 100 must anticipate the movements of other agents (other vehicles 101, 102, 103 . . . ) on the road. However, inaccuracies in these predictions introduce uncertainties that require careful consideration. Therefore, there is a need for a system that could adjust confidence levels for certain vehicles based on their unique features.

When a brand's vehicles exhibit specific safety functions or consistent behaviors, particularly when autonomous driving (AD) or Advanced Driver Assistance Systems (ADAS) are activated, the host vehicle can place greater trust in their trajectory. For example, if the host vehicle is aware that a particular vehicle does not permit lane changes in the presence of another vehicle on that lane, it can proceed with more confidence.

FIG. 1B shows an autonomous vehicle's predicted trajectory and safe distances according to an embodiment. Autonomous vehicles (AV) need to drive cautiously to avoid being exposed to hazardous situations. For instance, an autonomous vehicle needs to reduce the speed or adapt the trajectory both longitudinally and/or laterally, if there is possibility that another vehicle enters into the future trajectory of the host vehicle. There should always be a certain safe distance in the predicted trajectory of other vehicles, regardless of whether other vehicles being under autonomous control, semi-autonomous control, or human control. The assumption normally is without considering what other vehicles are capable of in terms of brands and models.

Host vehicle 150 may plan a trajectory 151 by considering the predicted paths of the other vehicles (152, 153, 154, 155 . . . ). The trajectory 151 includes safety margins 156 and 157 based on uncertainty zone 158 of the predicted paths of the other vehicles, for example, vehicle 155. A safety margin may act as the maximum error or deviation that may be permissible for host vehicle 150 while traveling along the predicted path, which is trajectory 151. In an example, uncertainty zone 158 is formed considering vehicle 155 path to be one of either continuing in the same lane or moving to the right lane. Since vehicle 150 is moving to the right lane, the risk from vehicles 152 and 154 may be less when compared to vehicles 153 and 155.

In general, precautionary behaviors of vehicles on road possibly lead to conservative driving, which slows the traffic flow down and reduces the customer satisfaction but also might raise issues of safety. There are multiple sensors, like cameras, that have the possibility to detect the specific characteristics of the vehicles around like brand logo, or other unique symbols of that vehicle. The host vehicle may use the vision system of the vehicle to detect the brand and model of the target vehicle and use the information from that brand and model in behavior planning of the host vehicle.

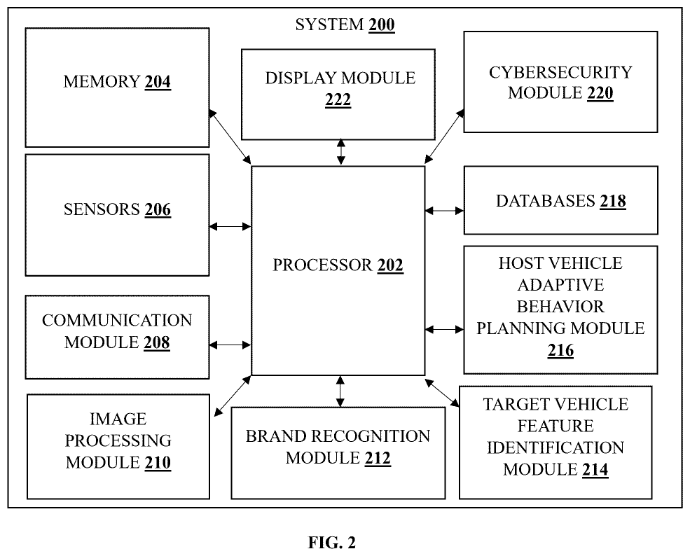

FIG. 2 shows a block diagram of the system for real-time vehicle identification for adaptive behavior in self-driving vehicles according to an embodiment. The system 200 comprises a processor 202, memory 204, sensors 206, communication module 208, image processing module 210, brand recognition module 212, target vehicle feature identification module 214, host vehicle adaptive behavior planning module 216, database 218, and cybersecurity module 220.

Processor 202 may be a high-performance, multi-core CPU or system-on-chip (SoC) solution to process vast amounts of data from various sensors that may be used. Processor 202 processes data from sensors, such as cameras, LIDAR, radar, and other inputs to make real-time decisions, recommendations, and to execute control actions for the vehicle. Processor 202 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, detect users, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. The processor interacts and exchanges data with one or more of the other components or modules of the system, for example, memory 204, sensors 206, communication module 208, image processing module 210, brand recognition module 212, target vehicle feature identification module 214, host vehicle adaptive behavior planning module 216, databases 218, and cybersecurity module 220 as shown in FIG. 2.

Memory 204 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

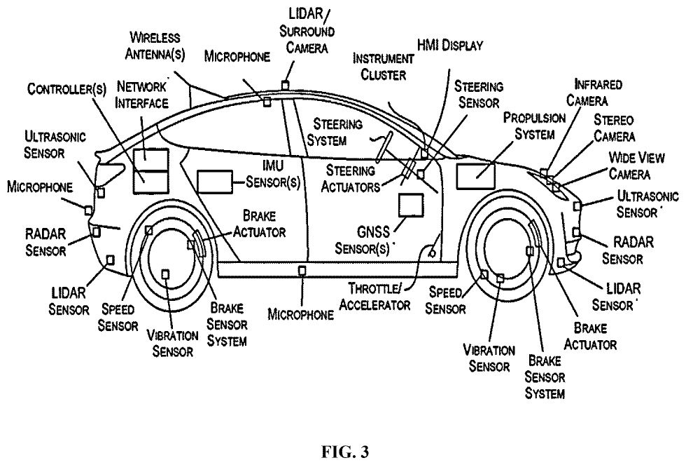

Sensors 206 comprises various sensors, such as ultrasonic sensor, light detection and ranging (LIDAR) sensors, radio detection and ranging (RADAR) sensors, camera-based sensors, infrared (IR) sensors etc., actuators such as brake actuators, steering actuators, etc., and various subsystems such as propulsion system, steering system, brake sensor system, communication system, etc. FIG. 3 is an illustration of a vehicle with various sensors, actuators, and systems according to an embodiment. The system depicted in FIG. 3 is for an example and is neither limited by the systems depicted nor is it an exhaustive list of the sensors, actuators, and systems/subsystems, and/or features of the autonomous vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the autonomous vehicle. Autonomous vehicles, also known as self-driving vehicles or driverless vehicles, are vehicles that can navigate and operate without human intervention. Sensors, for example, including cameras, LIDARs, radars, and ultrasonic sensors enable autonomous vehicles to detect and recognize objects, obstacles, and pedestrians on the road. Autonomous vehicles use advanced control systems to make real-time decisions based on sensor data and pre-programmed rules or intelligence-based decision systems. These systems control, for example, acceleration, braking, steering, and communication of the vehicle. Navigation systems such as GPS, maps, and other location-based technologies help autonomous vehicles navigate and plan the optimal route to a destination. Communication systems of autonomous vehicles help them communicate with other vehicles and infrastructure, such as traffic lights and road signs, to exchange information and optimize traffic flow. Autonomous vehicles have several safety features, including collision avoidance systems, emergency braking, and backup systems in case of system failures. Autonomous vehicles are assisted by artificial intelligence and machine learning algorithms to analyze data, recognize patterns, and improve performance over time.

According to an embodiment of the method, the sensor comprises one or more of an image sensor, a light detection and ranging sensor, a radio detection and ranging sensor, an ultrasonic sensor, a microphone, and an infrared sensor. According to an embodiment of the system, the sensor comprises one or more of an image sensor, a light detection and ranging sensor, a radio detection and ranging sensor, an ultrasonic sensor, a microphone, and an infrared sensor.

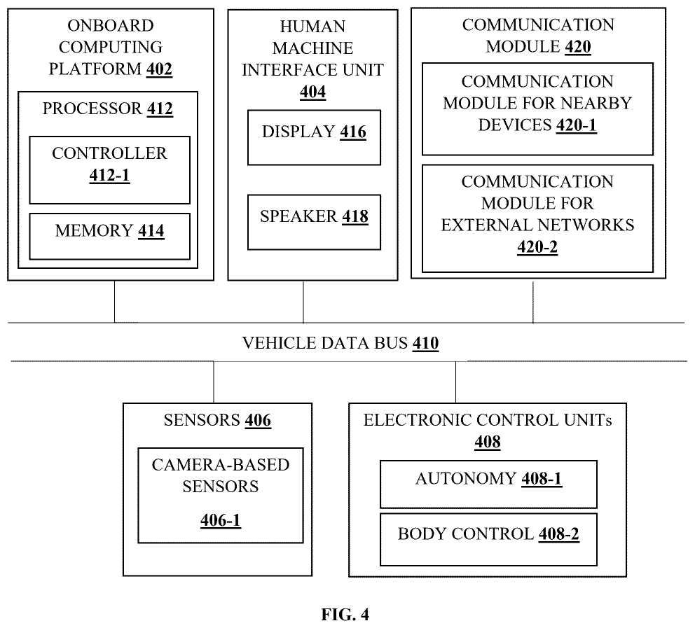

Communication module 208 facilitates communication between different modules within the system, communication between the user device and the vehicle. FIG. 4 shows a block diagram of electronic components of a vehicle according to an embodiment. In the illustrated example, the electronic components include an onboard computing platform 402, a human-machine interface (HMI) unit 404, the communication module 420, sensors 406, electronic control units (ECUs) 408, and a vehicle data bus 410. FIG. 4 illustrates an example architecture of some of the electronic components as displayed in FIG. 3. The onboard computing platform 402 includes a processor 412 (also referred to as a microcontroller unit or a controller) and memory 414. In the illustrated example, processor 412 of the onboard computing platform 402 is structured to include the controller 412-1. In other examples, the controller 412-1 is incorporated into another ECU with its own processor and memory. The processor 412 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 414 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 414 includes multiple kinds of memory, particularly volatile memory, and non-volatile memory. Memory 414 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 414, the computer-readable medium, and/or within the processor 412 during execution of the instructions.

The Human Machine Interface (HMI) unit 404 provides an interface between the vehicle and a user. The HMI unit 404 includes digital and/or analog interfaces (e.g., input devices and output devices) to receive input from, and display information for, the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), haptic devices, actuators, a display 416 (e.g., a heads-up display, a center console display such as a liquid crystal display (LCD), an organic light emitting diode (OLED) display, a flat panel display, a solid state display, etc.), and/or a speaker 418. For example, the display 416, the speaker 418, and/or other input and output device(s) of the HMI unit 404 are operable to emit an alert, such as an alert to request manual takeover to an operator (e.g., a driver) of the vehicle. Further, the HMI unit 404 of the illustrated example includes hardware (e.g., a processor or controller, memory, storage, etc.) and software (e.g., an operating system, etc.) for an infotainment system that is presented via display 416.

Sensors 406 are arranged in and/or around the vehicle to monitor properties of the vehicle and/or an environment in which the vehicle is located. One or more of the sensors 406 may be mounted to measure properties around an exterior of the vehicle. Additionally, or alternatively, one or more of sensors 406 may be mounted inside a cabin of the vehicle or in a body of the vehicle (e.g., an engine compartment, wheel wells, etc.) to measure properties of the vehicle and/or interior sensing of the vehicle. For example, the sensors 406 include accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. Sensors may comprise camera-based sensors 406-1 such as LIDAR, radar, cameras, ultrasonic sensors, GPS sensors, etc., configured for object detection/detecting distances between the vehicle and an object or target in its vicinity. According to an embodiment, the one or more sensors associated with the vehicle comprises one or more of a magnetic sensor, a proximity sensor, a load sensor, an electrical sensor, and a vision sensor, a motion sensor, a temperature sensor, and a GPS sensor. According to an embodiment, the one or more sensors associated with the vehicle comprises a camera coupled with a computer vision system.

The ECUs 408 monitor and control the subsystems of the vehicle. For example, the ECUs 408 are discrete sets of electronics that include their own circuit(s) (e.g., integrated circuits, microprocessors, memory, storage, etc.) and firmware, sensors, actuators, and/or mounting hardware. The ECUs 408 communicate and exchange information via a vehicle data bus (e.g., the vehicle data bus 410). Additionally, the ECUs 408 may communicate properties (e.g., status of the ECUs, sensor readings, control state, error, and diagnostic codes, etc.) and/or receive requests from each other. For example, the vehicle may have dozens of the ECUs that are positioned in various locations around the vehicle and are communicatively coupled by the vehicle data bus 410.

In the illustrated example, the ECUs 408 include the autonomy unit 408-1 and a body control module 408-2. For example, the autonomy unit 408-1 is operable to perform autonomous and/or semi-autonomous driving maneuvers (e.g., defensive driving maneuvers) of the vehicle based upon, at least in part, instructions received from the controller 412-1 and/or data collected by the sensors 406 (e.g., object detection sensors). Further, the body control module 408-2 controls one or more subsystems throughout the vehicle, such as power windows, power locks, an immobilizer system, power mirrors, etc. For example, the body control module 408-2 includes circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc.

The vehicle data bus 410 communicatively couples the communication module 420, the onboard computing platform 402, the HMI unit 404, the sensors 406, and the ECUs 408. In some examples, the vehicle data bus 410 includes one or more data buses. The vehicle data bus 410 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module for nearby devices 420-1 is operable to communicate with other nearby communication devices. In the illustrated example, communication module 420 includes a dedicated short-range communication (DSRC) module. A DSRC module includes antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, the communication module for external networks 420-2 includes a cellular vehicle-to-everything (C-V2X) module. A C-V2X module includes hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices, etc.) directly and/or via cellular networks. Currently, standards related to C-V2X communication are being developed by the 3^{rd} Generation Partnership Project. Further, the communication module 420-2 is operable to communicate with external networks. For example, the communication module 420-2 includes hardware (e.g., processors, memory, storage, antenna, etc.) and software to control wired or wireless network interfaces. In the illustrated example, the communication module 420-2 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 420-2 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet; a private network, such as an intranet, or combinations thereof, and may utilize a variety of networking protocols now available or later developed including, but not limited to, TCP/IP-based networking protocols.

In an embodiment of the system, the Vehicle-to-Vehicle (V2V) communication is based on wireless communication protocols using at least one of a Dedicated Short-Range Communications (DSRC), and a Cellular Vehicle-to-Everything (C-V2X) technology. In an embodiment, the communication module is enabled for an autonomous communication, wherein the autonomous communication comprises communication over a period with minimal supervision under different scenarios. The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 408-1 of the illustrated example is operable to perform autonomous and/or semi-autonomous driving maneuvers, such as defensive driving maneuvers, for the vehicle. For example, the autonomy unit 408-1 performs the autonomous and/or semi-autonomous driving maneuvers based on data collected by the sensors 406. In some examples, the autonomy unit 408-1 is operable to operate a fully autonomous system, a park-assist system, an advanced driver-assistance system (ADAS), and/or other autonomous system(s) for the vehicle.

Further, in the illustrated example, controller (or control module) 412-1 is operable to monitor an ambient environment of the vehicle, to enable the autonomy unit 408-1 to perform autonomous and/or semi-autonomous driving maneuvers. The controller 412-1 collects data that is collected by sensors 406 of the vehicle. In some examples, the controller 412-1 collects location-based data via the communication module 420-1 and/or another module (e.g., a GPS receiver) to facilitate the autonomy unit 408-1 in performing autonomous and/or semi-autonomous driving maneuvers. Additionally, the controller 412-1 collects data from (i) adjacent vehicle(s) via the communication module 420-1 and V2V communication and/or (ii) roadside unit(s) via the communication module 420-1 and V2I communication to further facilitate the autonomy unit 408-1 in performing autonomous and/or semi-autonomous driving maneuvers.

In some embodiments, controller 412-1 is operable to determine the takeover time of the adjacent vehicle based on measured characteristics of the vehicle and measured characteristics of the adjacent vehicle (e.g., velocity, acceleration, dimensions, etc.), the operator of the adjacent vehicle (e.g., a measured reaction time, etc.), and/or an environment of the adjacent vehicle (e.g., road conditions, weather conditions, etc.). Further, the time-to-collision corresponds with the time it would take for the adjacent vehicle to collide with another vehicle (e.g., a third vehicle) and/or object (e.g., a guardrail, a highway lane divider, etc.) if the current conditions were maintained.

According to an embodiment, the vehicle-to-vehicle (V2V) communication is based on a wireless communication protocol using at least one of a Dedicated Short-Range Communications (DSRC), and a Cellular Vehicle-to-Everything (C-V2X) technology. According to an embodiment, the V2X communication includes at least one of a Vehicle-to-Network (V2N), Vehicle-to-Grid (V2G), Vehicle-to-Device (V2D), and Vehicle-to-Pedestrian (V2P). The system notifies nearby or surrounding vehicles or vehicles communicating with the vehicle's communication module.

In an embodiment, a connection is established between a vehicle and the user device. The user device is detected by exchanging handshaking signals. Handshaking is the automated process for negotiation of setting up a communication channel between entities. The processor sends a start signal through the communication channel in order to detect a user device. If the user device receives the signal, the processor may receive an acknowledgement signal from the user device. Upon receiving the acknowledgement signal, the processor establishes a secured connection with the user device. The processor may receive a signal at the communication module from the user device. The processor may further automatically determine the origin of the signal. The processor communicatively connects the communication module to the user device. Then the processor is operable to send and/or receive a message to and/or from the user device. The signals received by the communication module may be analyzed to identify the origin of the signal to determine the location of the user device.

In an embodiment, the system is enabled for bidirectional communication. The system or vehicle sends a signal and then receives a signal/communication from the user device. As a first step of the method according to the disclosure, a data link between the vehicle and the external device is set up in order to permit data to be exchanged between the vehicle and the user device in the form of a bidirectional communication. This can take place, for example, via a radio link or a data cable. It is therefore possible for the user device to receive data from the vehicle or for the vehicle to request data from the user device. In an embodiment, bidirectional communication comprises the means for data acquisitions and are designed to exchange data bidirectionally with one another. In addition, at least the vehicle comprises the logical means for gathering the data and arranging it to a certain protocol based on the receiving entity's protocol. Initially, a data link for bidirectional communication is set up. The vehicle and the user device can communicate with one another via this data link and therefore request or exchange data, wherein the data link can be implemented, for example, as a cable link or radio link. Bidirectional communication has various advantages as described herein. In various embodiments, data is communicated and transferred at a suitable time interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional communication may be used to facilitate data exchange.

In an embodiment, the vehicle may transmit a message via a communication link. It can be using any combination of vehicle to vehicle (V2V), vehicle to everything (V2X) or vehicle to infrastructure (V2I) type of communication.

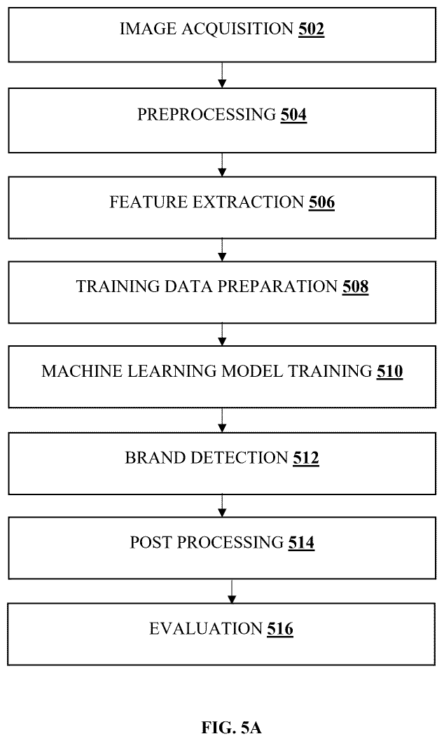

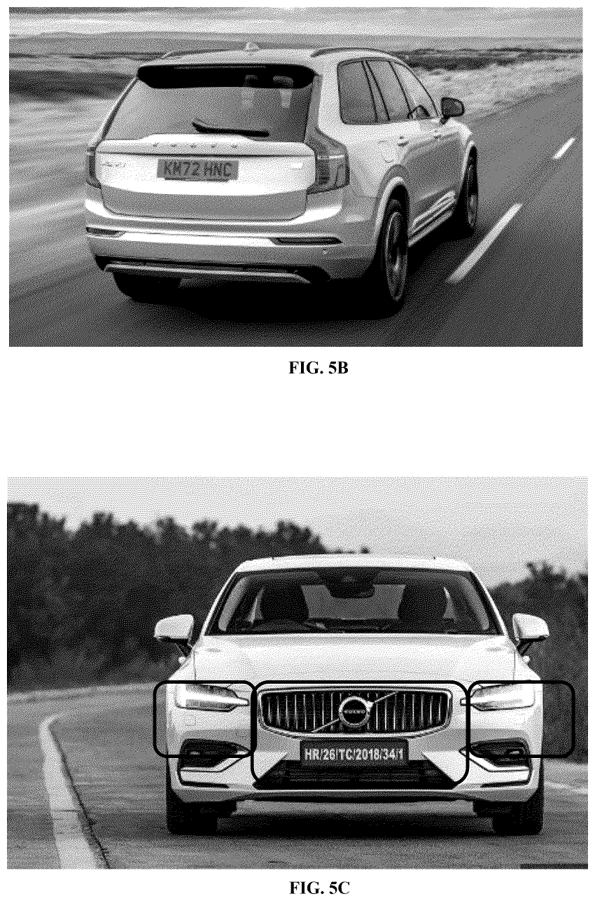

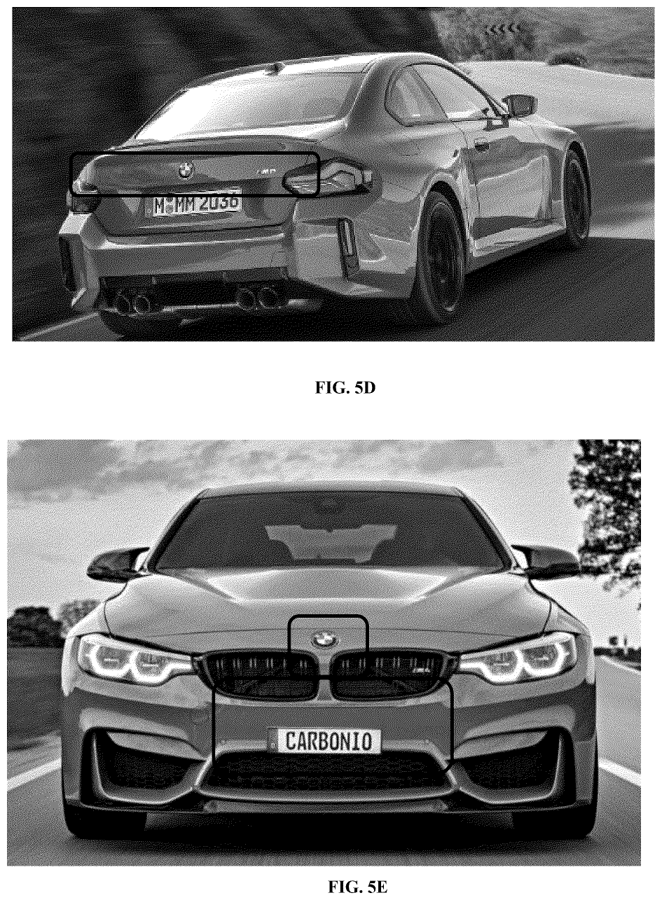

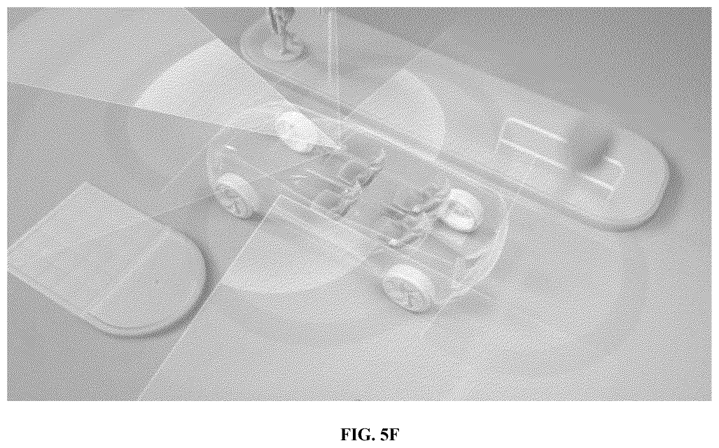

Image Processing Module 210 is configured for detecting a brand using image processing. FIG. 5A shows a flow chart for detecting a brand using image processing according to an embodiment. It comprises the following steps:

Image Acquisition 502: Capture or obtain images of target vehicles in the path of the host vehicle. This could be done using cameras mounted on vehicles, or images obtained from other sources or other sensors installed in the host vehicle such as lidar, radar, ultrasonic, IR camera sensors.

Preprocessing 504: Preprocess the images to enhance their quality and make them suitable for analysis. This may involve tasks such as resizing, noise reduction, and contrast enhancement.

Feature Extraction 506: Feature Extraction for vehicle brand recognition involves identifying and extracting distinctive elements from images that characterize different vehicle brands, transforming raw image data into a set of usable features for machine learning models. The step comprises identifying distinctive features that can be used to differentiate between different vehicle brands. This could include characteristics such as logos, emblems, or unique design elements specific to each brand such as body shape, body size, tail lamp shape, and any other characteristics such as color, noise, etc. In this step, distinctive features that can be used to differentiate between different vehicle brands are identified and extracted.

A bounding box method may be used in feature extraction, especially in object detection tasks within image processing. This method involves drawing rectangular boxes around objects of interest in an image, effectively isolating them from the rest of the scene. The bounding box technique simplifies the task of feature extraction by focusing the analysis on a specific region containing the target object, such as a vehicle or its logo. Once the bounding box is defined, various feature extraction techniques can be applied to the enclosed area. For instance, edge detection can identify the contours of the logo, key point detection can locate and describe significant points within the bounding box, and color or texture analysis can further characterize the visual attributes of the enclosed object. By narrowing the scope to the bounding box, the process becomes more efficient and precise, enhancing the accuracy of detecting and classifying features that are crucial for recognizing different vehicle brands. This method is particularly beneficial in complex images with multiple objects or noisy backgrounds, as it reduces the computational load and focuses on the most relevant portions of the image. According to an embodiment of the system, the image processing module comprises bounding box algorithm and edge detection algorithm.

The process further includes edge detection to find object boundaries using techniques like the Canny Edge Detector and Sobel Operator such as outlines of logos or brand-specific design, and key point detection and description to identify local features invariant to scale and rotation with methods such as methods like Scale-Invariant Feature Transform (SIFT), Speeded-Up Robust Features (SURF), or Oriented FAST (Features from Accelerated Segment Test) and Rotated BRIEF (ORB) configured to identify and describe key points in the image. It may further comprise color analysis which employs color histograms and segmentation to utilize color information; texture analysis which may use Local Binary Patterns and Gabor Filters to capture surface quality; Shape analysis that identifies geometric shapes using Hough Transform and contour detection. Deep learning-based feature extraction leverages Convolutional Neural Networks (CNNs) to automatically learn hierarchical features, using architectures like Residual Networks (ResNet), Visual Geometry Group (VGG), and Inception.

Training Data Preparation 508: This step involves creating a dataset of images labeled with the corresponding vehicle brands. It involves gathering a diverse set of images representing various brands and conditions (e.g., different angles, lighting conditions) and annotating the images with the correct brand labels. Then the dataset can be used to train a machine learning model to recognize brands from images.

Machine Learning Model Training 510: This step involves training a machine learning model, such as a convolutional neural network (CNN), using the labeled dataset. The model learns to recognize patterns and features associated with each brand. An appropriate CNN architecture for example, Residual Networks (ResNet), Visual Geometry Group (VGG), Inception may be chosen. Then the labeled dataset is fed into the model allowing it to learn the features through multiple iterations. Further, the model is tested using a validation set to tune hyperparameters and prevent overfitting.

Brand Detection 512: This step involves applying the trained model to new images to detect and classify vehicle brands. Evaluation could be either using images from a picture or a camera feed in real-time. The model will extract the features from the images, analyze the features, and predict the brand of each vehicle or the vehicles of interest in the images.

Post-processing 514: This step involves refining the results, if necessary, by applying post-processing techniques such as filtering or thresholding to improve accuracy and remove false positives. It involves applying spatial or temporal filters to smooth out the predictions and setting confidence thresholds to determine the acceptance of predictions.

Evaluation 516: This step involves evaluating the performance of the brand detection system using metrics such as accuracy, precision, recall, and F1-score. The F1 score or F-measure is described as the harmonic mean of the precision and recall of a classification model. The two metrics contribute equally to the score, ensuring that the F1 metric correctly indicates the reliability of a model. Based on the model's output, the system adjusts parameters or refines the model as needed to improve performance.

An image processing system capable of detecting vehicle brands from images is developed and deployed in a vehicle. Accuracy of the system depends on factors such as the quality of the training data, the effectiveness of feature extraction, and the performance of the machine learning model.

FIG. 5B shows an image processing module capturing and analyzing the image with a brand name and/or brand characteristic design feature for brand detection according to an embodiment. FIG. 5C shows an image processing module capturing and analyzing the image with a brand name and/or brand characteristic design feature for brand detection according to an embodiment. FIG. 5D shows an image processing module capturing and analyzing the image with a brand name and/or brand characteristic design feature for brand detection according to an embodiment. FIG. 5E shows an image processing module capturing and analyzing the image with a brand name and/or license plate for brand detection according to an embodiment. The system captures other vehicles around the host vehicle and the unique symbols of the vehicles are identified and then the identification of the brand with the confidence will be the output of the system. The identifiers are not limited to the logo and can be the shape of the lamp or other specific characteristics of that model or brand.

According to an embodiment of the method, the characteristic comprises one or more of a logo, a registration plate, a tail lamp, a shape of the target vehicle, and a size of the target vehicle. According to an embodiment of the method, the characteristic comprises one or more of a logo, a registration plate, a tail lamp, a shape of the target vehicle, and a size of the target vehicle. According to an embodiment of the method, a first identity comprises one or more of a brand, a model, and a make. According to an embodiment of the method, a second identity comprises one or more of a brand, a model, and a make.

According to an embodiment of the system, the characteristic comprises one or more of a logo, a registration plate, a tail lamp, a shape of the target vehicle, and a size of the target vehicle. According to an embodiment of the system, the first identity comprises one or more of a brand, a model, and a make. According to an embodiment of the system, the second identity comprises one or more of a brand, a model, and a make.

FIG. 5F shows the sensing of surroundings from the vision system of the autonomous driving vehicle for brand detection according to an embodiment. The detection may be through the vision system of the vehicle and the sensors that are already implemented for AD vehicles. The search starts with the existing frames from the vehicle, if any are identified, then the rest of the unique identifiers are identified by asking the vision system to further capture frames with more resolution from that part of the vehicle body.

According to an embodiment of the system, the image processing module comprises one or more artificial intelligence algorithms.

According to an embodiment of the method, the image processing module comprises one or more artificial intelligence algorithms, wherein the artificial intelligence algorithms are configured to: analyze the images of the region; extract features from the images; and classify and detect one or more of the brand, the make, and the model of the target vehicle. According to an embodiment of the method, the artificial intelligence algorithm is a convolutional neural network.

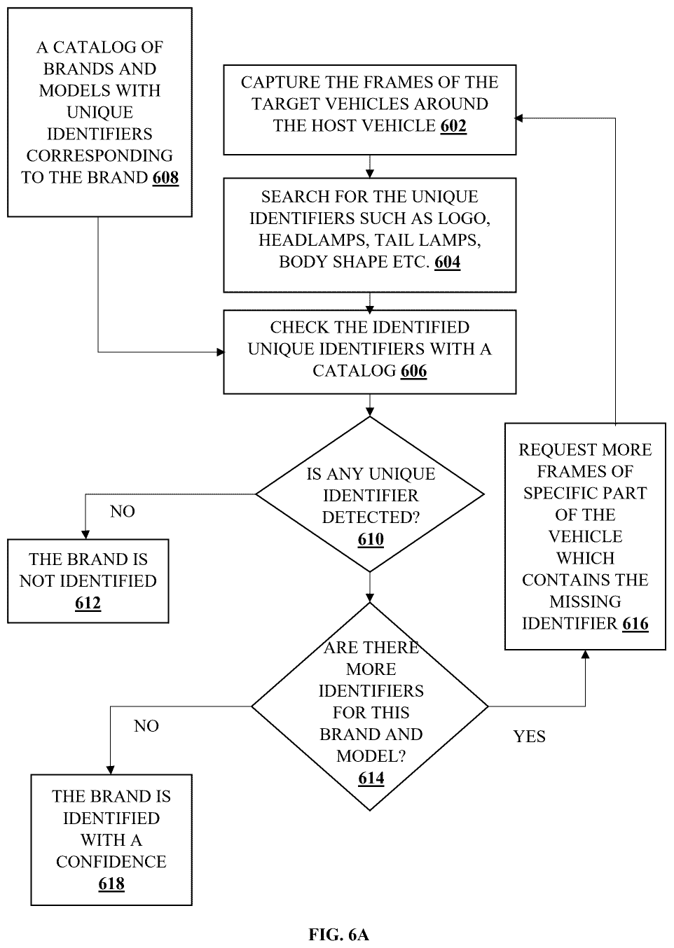

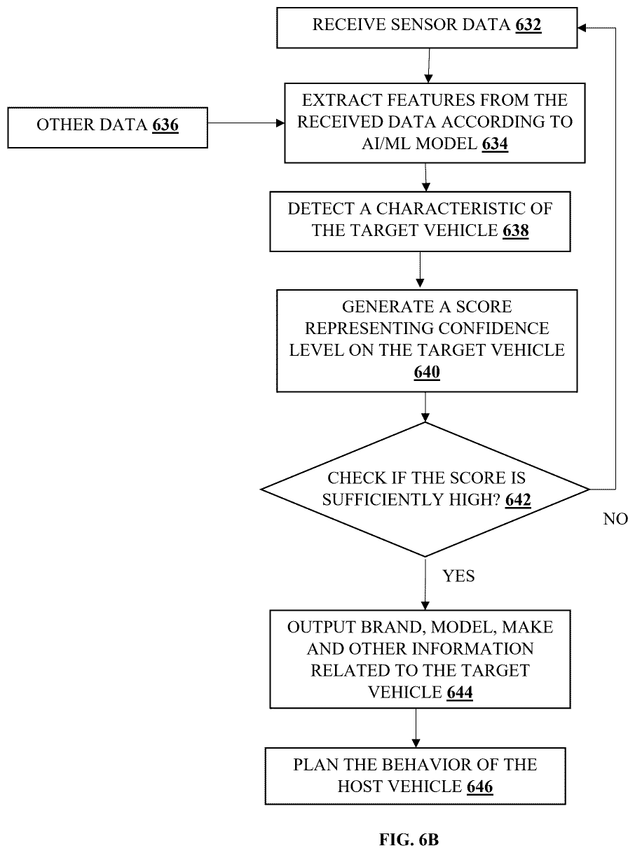

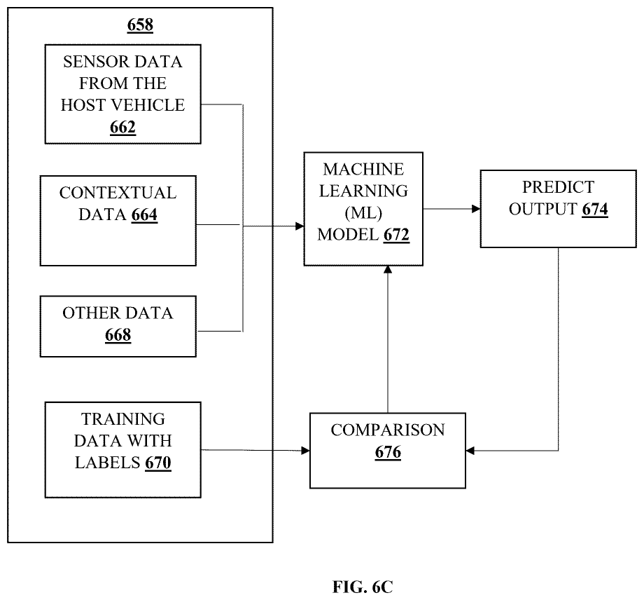

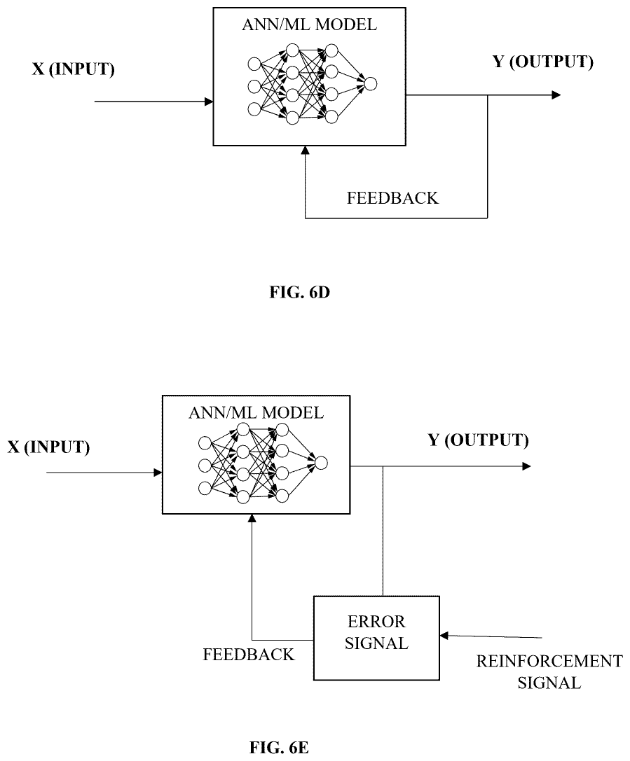

Brand Recognition Module 212 comprises various methods that can correlate vehicle features, for example logos, size, shape etc., with the brand name. FIG. 6A shows a method for brand recognition using vehicle features/characteristics according to an embodiment. It comprises the steps of capturing the frames of the target vehicles around the host vehicle at step 602; searching for the unique identifiers such as logo, headlamps, tail lamps, body shape etc., at step 604; checking the identified unique identifiers with a catalog at step 606; a catalog comprising brands and models with unique identifiers corresponding to the brand 608 may be stored to a database and made available for the comparison; at step 610, the method checks if any unique identifier is detected; if not, the process ends by providing an output that the brand is not identified at step 612; if unique identifiers are identified at step 610, the brand proceeds to check if there are more identifiers for the brand and model at step 614; if there are, then the method is directed to request more frames of the specific part of the vehicle which contains missing identifiers at step 616; if there are no more unique identifiers at step 614, then the method is directed to determine and identify the brand with a confidence level at step 618. In an embodiment, the system can browse through catalogs in a database of the vehicle or in the cloud which are shared with the public or through V2V.

FIG. 6B shows a flowchart for detecting the brand of a target vehicle and behavior planning of the host vehicle using a machine learning model according to an embodiment. The host vehicle system is operable for continuous monitoring and adaptively adjusting the host vehicle behavior based on the presence of the target vehicles along the path of the host vehicle. The system may receive real-time data from the sensors associated with the vehicle as shown at step 632. Any type of sensor may be used to gather data pertaining to the vehicle. A sensor output may be, for example, images, videos, audios, LIDAR measures, infrared measures, temperature measures, GPS data, or any other information measured or detected by sensors. In an embodiment, a sensor output may be the result of one or more sensors capturing environmental information associated with the surroundings of the vehicle, which may include traffic at the location, road surface condition, etc. The system may receive any data associated with the sensor output from sensors, including raw sensory output and/or any derivative data. In an embodiment, the system may process the received data and identify any actionable parameter of interest using a machine learning model trained using a set of training data. It may receive other data at step 636, such as weather conditions, road conditions, traffic conditions, humidity, temperature, driver behavior, tire tread, tire conditions, tire pressure, etc., from the host vehicle sensors or from any other external sensors some of which may be present on the target vehicle.

As shown at step 634, the system may extract features from the received data from the sensors according to a machine learning model. The machine learning model is able to automatically do so based on what it learned during the training process. In an embodiment, appropriate weights that were learned during the training process may be applied to the features.

As shown at step 638, the machine learning model, based on the features of the received data, may detect a characteristic of the target vehicle. Characteristics of the vehicle may include its brand, model, make, safety features, etc. The model may detect the brand based on one or more features that are identified. In an example, based on the logo alone it may detect the brand with high confidence. In another example, it may use more than one feature to detect the brand.

As shown at step 640, the machine learning model may generate a score representing a confidence level on the detected characteristics of the target vehicle or the target vehicle itself. Each of the identified characteristics may carry certain weightage. For example, a logo, if captured, may be given high weightage as compared to a shape of the tail lamp or body shape and thus the output of detecting a behavior based on the characteristic of the vehicle may also have a high confidence level.

As shown at step 642, the system may determine whether the confidence level on the target vehicle is sufficiently high relative to a threshold or criteria. If the score is not sufficiently high, thus indicating a false-positive, the system may return to step 632 and continue to monitor subsequent incoming data. On the other hand, if the score is sufficiently high, then at step 644 the system may output the brand, make, model, and any other information related to the vehicle, for example, what safety features are available, what safety features would have been installed by default, and what might be active by default etc.

As shown at step 646, the system may plan the behavior of the host vehicle based on the confidence level on the detected brand of the target vehicle. Steps 632-644 may be repeated on one or more target vehicles present in the path of the host vehicle. Steps 632-644 may be repeated on a group of target vehicles that may be relevant to the predicted maneuver of the host vehicle so as to modify or adjust the maneuver. The machine learning model is able to automatically be based on the learning process.

In an embodiment, the system may repeat one or more steps of the method where appropriate. In an embodiment, the steps 632 to 646 may be performed by the system, any combination of those steps may be performed by any other computing systems, for example, a remote network or a cloud network. In an embodiment, where machine learning models are used for making such determination, the system may transmit a trained machine learning model to the computing system in the vehicle. This may be desirable since sensor data may be overly large to transmit to the in-vehicle system for training in a timely fashion. In an embodiment, the system is provided, wherein the machine learning model utilizes a Convolutional Neural Networks (CNN). In an embodiment, it may use a recurrent neural network architecture because of its ability to use past, temporal information for inference on current inputs.

In an embodiment, an alert may be generated to draw immediate attention to specific events, conditions, or situations that require prompt action or awareness. For example, an alert signal alerts the user when the brand is not detected or when the brand is detected with low confidence level. These alert signals are designed to be noticeable, distinctive, and easily recognizable, ensuring they effectively convey the urgency of the situation to the intended recipients. In an embodiment, alerts may be audible alarms. They can range from simple beeps or chimes to attention-grabbing sirens. In an embodiment, an alert may be a visual alert. Bright and conspicuous visual signals, such as flashing screen, flashing LED displays, flashing text, are employed to draw attention. In addition to auditory and visual alert, haptic feedback may also be present. Haptic feedback provides alert signals through tactile sensations, such as vibrations or pulses. This form of alert may be used in smartphones and wearable devices to notify users of the messages without relying solely on sound or visuals. In an embodiment, it may be a text message, an email, and app notifications are also utilized to generate alert signals on electronic devices. In various contexts, alert signals are used to notify drivers of potential safety issues, for example, when the brand of the target vehicle is not detected and there is a potential safety issue that the target vehicle may come in the path of the planned trajectory of the host vehicle. Thus, the system may plan the trajectory with high safety margins. Alternatively, the system may adopt a more conservative behavior in its planned trajectory when such a target vehicle with low confidence score is around.

The effectiveness of alert signal generation depends on factors such as the clarity of the signal, the urgency of the situation, and the attention of the intended recipients. Proper design and consideration of the context are taken care of to ensure that alert signals serve their intended purpose and effectively communicate important information to the users. In an embodiment, one or more of audible alarms, visual alerts, haptic feedback, text messages, vehicle alerts are used in keeping users informed about issues related to safety and recommended actions. Alert signals for safety issues in vehicles are operable for ensuring that the occupants remain informed about the safety. One common method of generating an alert signal is through a warning light on the vehicle's dashboard. In addition to the warning light, the dashboard offers a continuous visual indication of the vehicle's safety and the surrounding traffic as icons on the dashboard.

FIG. 6C shows an example block diagram for brand detection and behavior planning using a machine learning model according to an embodiment. The machine learning model 672 may take as input any data associated with the host vehicle, sensor data from the host vehicle 662, and learn to identify features within the data that are predictive of target vehicle characteristics which then can be used as an input to the behavior planning of the host vehicle. The training data sample may include, for example, the vehicle data comprising vehicle identification number via license plate/registration plate, make and model, etc. It further comprises other characteristics such as sound profile, color, texture, design features, tail lamp and/or head lamp location, shape, size, etc. In an embodiment, it relates to systems and methods that identify a brand, make and model of a target vehicle in real-time using an on-board camera and/or other sensors of the vision system of the host vehicle. Over a period of time, various target vehicles and their behavior profiles may be grouped to learn the safety features that are available and activated by default or in real-time. The data related to the target vehicles and the classification and identification may be transmitted to the cloud. Some of the data may be historical data from target vehicles of similar brand, model, and make, in similar situations. Subsequently, the information is used to compute/predict the target vehicle behavior based on which the host vehicle behavior can be planned. Host vehicle behavior comprises one or more of following distance, speed adjustments, lane changes, and overtaking strategies. The systems and methods of the present disclosure may also provide data analytics information that may be used later to improve safety.

In an embodiment, the training data sample may also include contextual data 664 relating to the surrounding environment. This may include, for example, location of the host vehicle and the target vehicle, current weather conditions, temperature, time of day, traffic conditions in the region, number of lanes, other obstacles, uphill segments of the road, etc. The system may also garner contextual information from a device associated with the user. For example, through an application installed on the device, such as an online mapping service, like Google® maps, and location services, the system may know the vehicle details. Real-time sensor data may be collected which may include, for example, video, image, audio, infrared, temperature, 3D modeling, and any other suitable types of data that capture the current state around the vehicle. The current contextual information 664 includes real-time sensor data from the host vehicle and the external sensors/sources such as from traffic infrastructure.

Other data 668 may include data derived from host vehicle sensor data and target vehicle's predicted brand. In an example, other data may include a scenario under which the target vehicle behavior has to be determined, such as given two identified and trusted brand target vehicles and one non trusted brand with no safety features, what should be the host vehicles behavior. In an example, manufacturers specification for the target vehicle, database of default features active in a specific brand, etc., are retrieved from a database.

Any of the aforementioned types of data (e.g., sensor data from the host vehicle 662, contextual data 664, other data 668) may correlate with the brand prediction of target vehicle and behavior of the host vehicle and may be automatically learned by the machine learning model 672. In an embodiment, during training, the machine learning model 672 may process the training data sample (e.g., one or more sensor data from the host vehicle 662, contextual data 664, other data 668), and, based on the current parameters of the machine learning model 672, predict output 674 which may be a brand prediction of the one or more target vehicles and subsequently determining a behavior of the host vehicle based on the predicted behaviors of the target vehicle brand for the given scenario. In an embodiment, the real-time sensor data may be processed using one or more machine learning models 672, trained and based on similar types of data to determine a host vehicle behavior based on a predicted brand of one or more target vehicles. The predicted output, which is the predicted brand of one or more target vehicles and determining the behavior of the host vehicle, may depend on the training data with labels 670 associated with the training data sample 658. In an embodiment, during training, the predicted output, and the training data with labels 670 may be compared. For example, comparison 676 may be based on a loss function that measures a difference between the predicted output and the training data with labels 670. Based on the comparison at 676 or the corresponding output of the loss function, a training algorithm may update the parameters of the machine learning model 672, with the objective of minimizing the differences or loss between subsequent predicted output 674 and the corresponding labels 670. By iteratively training in this manner, the machine learning model 672 may “learn” from the different training data samples and become better at predicting output 674, predicting a range that is similar to the ones represented by the training labels at 670. In an embodiment, the machine learning model 672 is trained using data which is specific to a vehicle brand for which the model is used for predicting adjustments to the behavior profiles of the host vehicle. In an embodiment, the machine learning model 672 is trained using data which is general to various vehicle brands and is used for predicting adjustments for the behavior of the host vehicle for safety and thus adapting the behavior based on real-time data.

Using the training data, a machine learning model 672 may be trained so that it recognizes features of various vehicles that signify or correlate to a specific brand and its features. For example, a trained machine learning model 672 may recognize data features that signify the likelihood of an impact on the safety of the host vehicle. Through training, the machine learning model 672 may learn to identify predictive and non-predictive features and apply the appropriate weights to the features to optimize predictive accuracy of the machine learning model 672. In embodiments where supervised learning is used and each training data sample 658 has a label 670, the training algorithm may iteratively process each training data sample 658 (sensor data from the host vehicle 662, contextual data 664, other data 668), and generate a predicted output 674 which is a brand detection (a target vehicle characteristic detection). Based on the comparison 676 results, the training algorithm may adjust the model's 672 parameters/configurations (e.g., weights) accordingly to minimize the differences between the generated predicted output 674 and the corresponding labels 670. Any suitable machine learning model and training algorithm may be used, including, e.g., neural networks, decision trees, clustering algorithms, and any other suitable machine learning techniques. Once trained, the machine learning model 672 may take input data associated with a target vehicle characteristic data and output detected brand, its confidence level and determine a behavior of the host vehicle for safety. In an embodiment, the machine learning model, 672 is an artificial neural networks (ANN) model.

FIG. 6D shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises data from the sensors of the host vehicle 662, contextual data 664, other data 668 and output comprises detection of one or more characteristics of the target vehicle based on which a host vehicle behavior can be planned in real-time. One or more characteristics comprise logo, head lamp style, shape, and placement, tail lamp style, shape, and placement, design features, color, texture, unique noise/sound etc. The model may learn from the data 658. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict one or more characteristics of the target vehicle based on which a host vehicle behavior can be planned in real-time.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models' performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., occupant type, occupant profile, priority levels for the profiles, limitations and priority levels, driving conditions, driver behavior, vehicle behavior, weather conditions etc.) are used that are meant for the model to learn how and what adjustments needs to be performed. Afterward, the model is tested using unlabeled data. By using, for example, deep learning and neural networks, the model can then make predictions on whether the desired output (for e.g., adjustments to the occupant settings and limitations to maximize safety, comfort etc.) is in the predicted range. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) in image processing for detecting an occupant and occupant data (ii) in safety prediction given adjustments to the vehicle settings etc.

FIG. 6E shows a structure of the neural network/machine learning model with reinforcement learning according to an embodiment. The network receives feedback, including error signals, from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

Target Vehicle Feature Identification Module 214 comprises a system and method for identifying the models and brands of other vehicles in the vicinity of the host autonomous vehicle so that the host vehicle's behavior can be planned by taking into consideration the capabilities and underlying functions enabled by the baseline software in the target vehicles. The system further comprises identification of the advanced features installed and activated in the vehicles. This information, together with the model and brands, can be useful for planning the behavior and trajectory for the self-driving autonomous vehicle driving in the defined operational design domain (ODD).

According to an embodiment, the system is configured for identification of advanced features activated in the detected or target vehicles. In comparison with the functions that are shipped with and enabled by the baseline software, advanced features, for example, certain active safety functions, ADAS or autonomous driving systems, are usually purchased as packages and need to be activated by the driver. Identifying (1) how those advanced functions work (2) if they are activated by the target vehicle would provide inputs to the planning and decision-making components of autonomous vehicles, for example to enhance confidence of the predictions.

The general problem here is to let autonomous vehicles learn what other vehicles are capable of and what kind of functions are currently enabled in order to adjust or optimize its subsequent behaviors or trajectory. The way of learning can be realized in various ways. A known solution may be to use V2V communication, either the vehicle broadcasting its enabled functions or let the host vehicle query such information via a message to receive the information.

In general, ADAS/AD consider the capabilities of the host AV but the capabilities are not considered from the other target vehicles in the vicinity.

According to an embodiment, V2V approach is used where the host vehicle can obtain the information of advanced functions activated in other vehicles. In another embodiment, using the vision system may be used for identifying advanced features. The identified information about the safety features of one or more target vehicles is used for planning or determining a maneuver of the host vehicle.

Identifying activated features in the target vehicle, for example, Blind Spot Information System (BLIS), which is an advanced safety feature found in many modern vehicles, including those from Volvo, help the host vehicle's predictions. BLIS is designed to enhance driver awareness and safety by monitoring the areas adjacent to and just behind the vehicle, commonly referred to as the blind spots. Using radar sensors or cameras, BLIS continuously scans these areas and alerts the driver through visual signals, typically on the side mirrors or A-pillars, when a vehicle is detected. A-pillar is the forward-most pillar on a vehicle, supporting its roof at each corner of the windshield. This system helps drivers make safer lane changes and maneuvers, reducing the likelihood of side-swipe collisions. Some advanced BLIS systems also include cross-traffic alerts for added safety when reversing. BLIS increases situational awareness and driver confidence by providing information about the vehicle's surroundings.

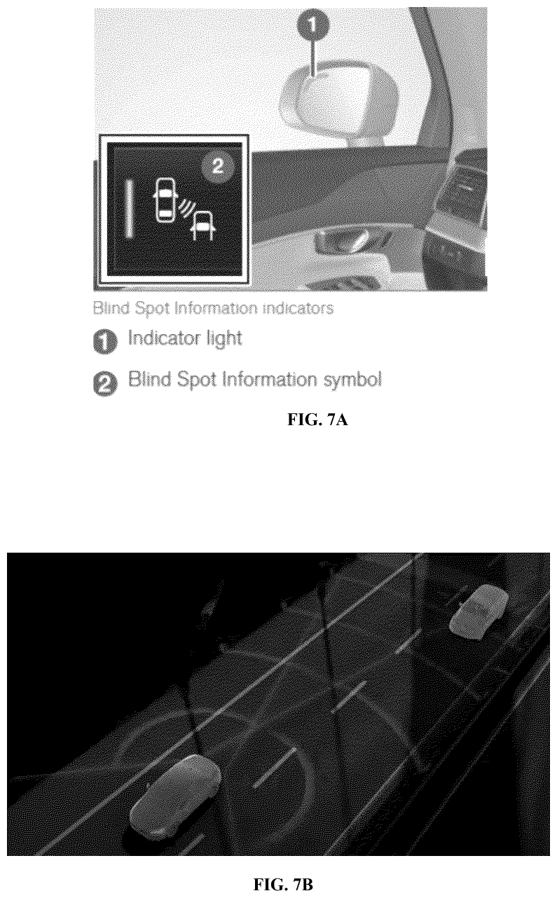

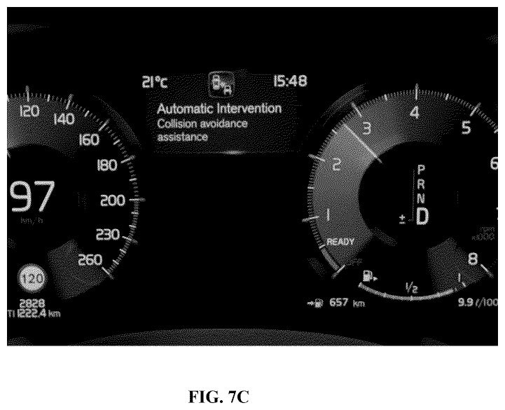

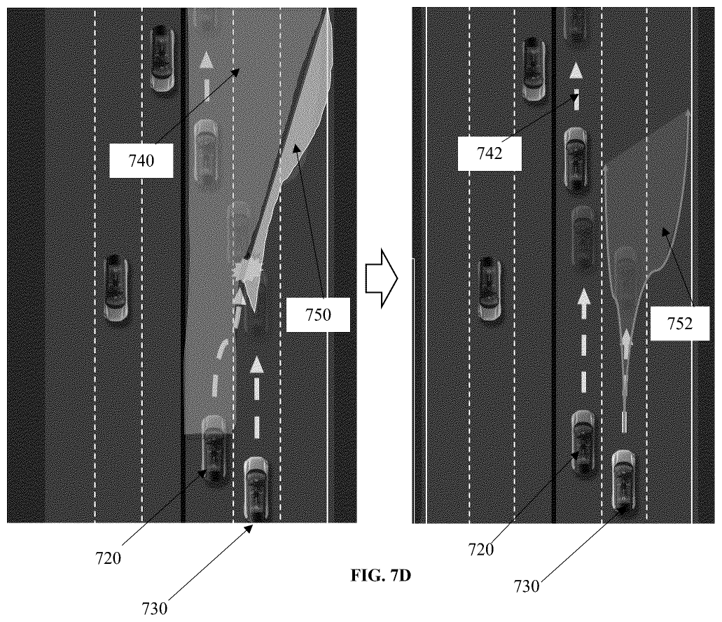

FIG. 7A shows a visual indicator for Blind Spot Information System (BLIS) according to an embodiment. Some brands and models are equipped with blind spot detection systems that identify vehicles in adjacent lanes and notify the driver by illuminating a light in one of the side mirrors as shown in FIG. 7A If the driver attempts to change lanes, the system may also initiate a lateral maneuver to bring the vehicle back to its lane, preventing a potential collision.

FIG. 7B shows a vision system of autonomous vehicles according to an embodiment. The host vehicle through a vision system detects the external signs of existence and activation of BLIS function, and then if BLIS light is on then the host AD vehicle has more confidence in the vehicle on the adjacent lane. It is because the BLIS is notifying that vehicle about the existence of the host vehicle. In some models and brands the BLIS system resists a change in the lane. Then the precautionary behavior of the host vehicle may be adapted. The vision system of autonomous vehicles comprises an array of cameras, sensors, and advanced image processing algorithms. These cameras, typically positioned around the vehicle, provide a 360-degree view of the surroundings, capturing high-resolution images and video in real-time. The system uses various types of cameras, including monocular, stereo, and fisheye, to gather detailed visual information. Image processing algorithms, such as convolutional neural networks (CNNs), analyze this visual data to identify and interpret objects, road signs, lane markings, traffic signals, and other vehicles and in addition these can be utilized to capture the visual indicators of advanced safety features that are activated. The vision system integrates this information to create a comprehensive understanding of the host vehicle's environment, enabling the autonomous vehicle to make informed decisions, navigate complex traffic situations, and ensure safe and efficient driving. The system also employs techniques like object detection, depth estimation, and semantic segmentation to enhance its perception capabilities, allowing the autonomous vehicle to react appropriately to dynamic conditions and potential hazards on the road.

Advanced safety features and Visual Indicators: Advanced safety features are designed to enhance driver, passenger, and pedestrian safety. These features include adaptive cruise control, which maintains a set speed and distance from the vehicle ahead by automatically adjusting the throttle and brakes. Lane-keeping assist helps prevent unintentional lane departures by gently steering the vehicle back into its lane. Automatic emergency braking detects imminent collisions with other vehicles or obstacles and applies the brakes to avoid or mitigate the impact. Blind-spot monitoring uses sensors to detect vehicles in adjacent lanes and warns the driver through visual or auditory signals. Additionally, rear cross-traffic alert monitors the area behind the vehicle while reversing and alerts the driver to approaching traffic. Other features like traction control, electronic stability control, and anti-lock braking systems (ABS) enhance vehicle stability and control, especially in adverse driving conditions. Advanced driver assistance systems (ADAS) also include features such as traffic sign recognition, which reads road signs and displays the information on the dashboard, and driver drowsiness detection, which monitors driver behavior for signs of fatigue and issues warnings to the driver to take a break. These technologies collectively contribute to reducing accidents and improving overall road safety.

Dashboard Indicators are provided for Adaptive Cruise Control (ACC), which displays set speed and distance to the vehicle ahead on the dashboard; Automatic Emergency Braking (AEB) which flashes a visual warning like “Brake!” or a red symbol on the dashboard; Traction Control and Electronic Stability Control (ESC) which provides dashboard indicators that light up when these systems are active or if there's a fault; Anti-lock Braking System (ABS) where Dashboard light illuminates briefly when the system activates; Traffic Sign Recognition which provides Display of recognized road signs, such as speed limits, on the dashboard; Driver Drowsiness Detection which provides visual alerts, often a coffee cup icon or message on the dashboard. In an embodiment, dashboard indicator visual signs may be made to reflect on a visual display that may be visible to external vehicles. In an embodiment, one or more of the visual indicators that are active on the main dashboard may be transmitted via communication module to the external vehicle.

Side Mirror or A-Pillar Indicators are used for Blind-Spot Monitoring (BSM) which illuminates warning lights in the side mirrors or A-pillars when a vehicle is in the blind spot, often flashing if the driver signals a lane change; Rear Cross-Traffic Alert (RCTA) which provides visual warnings on the side mirrors, indicating approaching vehicles while reversing. These visual indicators may be directly read by the nearby vehicle if the part is visible to the other vehicle. Otherwise, such a visual indicator may accompany V2V communication for one or more surrounding vehicles or via a broadcast signal.

Instrument Cluster or Heads-Up Display (HUD) is used for Lane-Keeping Assist (LKA) which shows visual warnings on the instrument cluster or heads-up display when the vehicle drifts out of its lane; Traffic Sign Recognition which displays recognized road signs on the heads-up display. FIG. 7C shows a display of advanced safety features that are enabled in autonomous vehicles on an instrument cluster according to an embodiment.

Rearview Camera Display may be used for Rear Cross-Traffic Alert (RCTA) which provides visual warnings on the rearview camera display, indicating approaching vehicles while reversing.

In an embodiment, the safety features are grouped based on their visual indicators and are stored to a repository by correlating them with a characteristic of the vehicle such as brand, make and model. Drivers can quickly understand and recognize the alerts provided by their vehicle's advanced safety systems, improving response time and overall safety.

In the near future, regulatory compliance may require AD features to have visible indicators when activated, which can be learned and recognized by the host AV. In an embodiment, such a repository of AD features created are stored in a database. The database may be local to the system or in the cloud. By identifying the brand and the Operational Design Domain (ODD) of these autonomous driving functions, the host AV can understand how the target vehicle handles different traffic situations. This information can then be utilized by the decision-making and planning components of the ego AV.

FIG. 7D shows the adapted behavior of the host vehicle after considering the target vehicle's capabilities according to an embodiment. Initially, the host vehicle 720 plans a lane change, but the target vehicle 730 does not have activated advanced safety features for collision avoidance. The host vehicle is unaware that the target vehicle is not autonomous or lacks active safety features, which creates a risk that when the host vehicle 720 enters zone 740, the target vehicle 730 might also move into the same zone 740 or its maneuver zone 750 which may be overlapping with zone 740. This overlap could potentially lead to a collision. However, if the host vehicle identifies or determines that the target vehicle 730 does not have advanced safety features enabled, such as adaptive cruise control, or if it is being manually driven instead of autonomously, or if safety features are disabled or malfunctioning, then it will adapt its maneuver. For example, upon recognizing that the target vehicle 730 lacks active safety features, the host vehicle may adjust its path to a new path 742 based on the predicted behavior of the target vehicle 752, and delay/avoid the lane change to a more suitable time to avoid collision. In an embodiment, the host vehicle may send a request message to slow down to the target vehicle, so that the host vehicle can make the planned maneuver.

### Using V2V Communication to Receive the Information on Advanced Safety Features

The vehicle-to-vehicle (V2V) or vehicle-to-infrastructure (V2I) communications are ways for vehicles to aggregate the information by their respective sensors. In an embodiment, integrating the visual detection of the brand and aggregating the target vehicle information via communication module, and cross verifying the two may be used to raise a cyber security concern on the system of the other vehicle. For example, if the neighboring vehicle is not a Volvo® vehicle, and the signal received is claiming it is as a Volvo®, then that is a mismatch, and the confidence on that signal is reduced.

Moreover, Vehicle to vehicle communication alone may raise some security concerns which may be addressed by visual detection of the model, and brand of the target vehicle and using the visual detection information to check the validity of identification of the other vehicle which is trying to connect by wireless communication protocols.

If there is a target vehicle in front of the host vehicle, the host vehicle would want to know the target vehicle's capabilities to maintain safe distances and communicate using the standard supported protocol and features. Identifying the target vehicle is useful for at least two reasons: i) Determining its capabilities: Based on the brand and model, the target vehicle's behavior, such as stopping capability, can be analyzed using historical data. This helps the host vehicle plan a safe distance to avoid potential collisions. ii) Communication: To communicate with a target vehicle of a different brand, such as a Volvo® communicating with a BMW®, the host vehicle needs to know the supported communication protocol of the target vehicle. The host vehicle may need to download or access the required protocol from memory to establish V2V communication.

In one embodiment, a virtual lasso and a virtual gap are maintained once the brand of the target vehicle is determined. Based on the detected brands of the surrounding vehicles and their capabilities, a safety zone around the vehicle can be made adaptive. This adaptive approach also incorporates the capabilities of the host vehicle.

In one embodiment, the host vehicle would ascertain the identity of the target vehicle to understand its capabilities. For example, while a standard V2V system might excel at basic communication, it may lack the ability to convey additional information about capabilities or specifications based on the vehicle's brand. However, V2V technology could be enhanced by allowing a vehicle to communicate supplementary details based on the brand, such as payload capacity or specific tasks it is undertaking, thereby enriching situational awareness. Moreover, knowledge of the vehicle's make, and model can provide more specific specifications, such as dimensions and turning radii, which are particularly relevant for passenger cars but could also be applicable to larger vehicles like trucks. These details can be obtained via a database based on brand or via V2V communication.

In an embodiment, the system is configured for identifying a brand and capabilities of the target vehicle based on the identified brand. In an embodiment, a two way communication is brand specific, for example the payload content will have additional details for certain brands having additional capabilities, whereas for other brands the payload could be basic content.

In an embodiment, the system is configured for visual detection of the identity of the vehicle, i.e., brand, make, model etc. of the vehicle. In an embodiment, the system is configured to discern the authenticity of a vehicle's communication. A V2V (vehicle-to-vehicle) communication may be used where one vehicle asserts its credibility to another. However, this approach presents challenges. Firstly, not all vehicles are equipped for V2V, with some brands having limited adoption. Secondly, there are cybersecurity concerns; malicious actors could potentially impersonate legitimate vehicles, leading to deception and potential risks.

In an embodiment, the preliminary solution could be to identify the brand and model of approaching vehicles initially visually, akin to how a human driver might assess another vehicle on the road. Additionally, consider capturing activated functions, such as exterior lights or other discernible features. Once a vehicle is identified, leverage known features common to that model, providing a basis for understanding its behavior, such that the vehicle would not permit lane change when another vehicle is seen at a certain distance. This would enable more informed trajectory planning, balancing safety, and user experience. In one embodiment, the aim is to enhance both the quality and safety of driving experiences.

In an embodiment, the system comprises detecting a registration plate and checking with the databases. The identity can then be cross-checked using vehicle to vehicle communication with the precaution of cybersecurity check. In another embodiment, sensors such as RADAR, LIDAR, ultrasonic can be used to detect some shape of the vehicle, and other features. In an embodiment, a microphone may be used to detect specific vehicles, like sports cars that would have a specific sound for the identification of the vehicle.

The security mechanism addresses potential deception in V2V communication scenarios. When a target vehicle communicates its presence, it essentially vouches for its identity. However, there is a risk of false claims. This mechanism enables the detection of the identity, for example a model and brand of the target vehicle, allowing for cross-referencing with the information received via V2V. Consequently, if the detected information matches the transmitted claim, trust can be established.

Additionally, a particular driving behavior may be exhibited by a target vehicle. For instance, even if the vehicle itself is deemed safe, the driver may be displaying erratic or inappropriate driving behavior. In an embodiment, the system may be monitoring specific instances, for example, the target vehicle that might be traveling at an excessive speed, erratic lane changes, or too slow, among other scenarios due to driver's behavior. In an embodiment, the system may account for the variability in driver behavior, assuming it to be uncertain. However, due to the vehicle's functionalities the likelihood of erratic maneuvers is comparatively lower than in other vehicles which may not have safety features embedded. For instance, in cases like Adaptive Cruise Control (ACC), if the target vehicle has high confidence based on its capabilities/features, which may be behind the host vehicle, the system would trust the target vehicle's capabilities, and the host vehicle may permit, or the driver of the host vehicle may opt for, more aggressive braking. The confidence on the target vehicle allows for greater deceleration, potentially minimizing the risk of rear-end collisions. It is worth noting that there are predefined deceleration limits to prevent such incidents. In these scenarios, the driver of the target vehicle may even be less involved, as the target vehicle's autonomous system takes over control.

In an embodiment, the system may not account for the uncertainty of driver behavior, assuming that the target vehicle's capabilities tend to mitigate the likelihood of reckless maneuvers, making them less frequent compared to other vehicles which may not be equipped with such capabilities. Consequently, the probability of, for instance, sudden lane changes in the target vehicle is lower when the target vehicle is having certain safety features embedded into it to prevent such sudden maneuvers or the system may take over for braking for safety.

In an embodiment, the system would consider not just the model of the vehicle, but also its specific type. For instance, an ambulance or a police vehicle typically exhibits more assertive driving behavior compared to regular vehicles. Therefore, it is important to be able to identify these types of vehicles as well. Whether it is a police vehicle, an ambulance, or a fire engine, each may operate with a heightened sense of urgency and may behave differently on the road. Thus, the system would consider and account for these distinctions based on the type of vehicle in our analysis. In an embodiment, the system would learn by familiarizing or training with various models of vehicles, including different types of ambulances and fire trucks, by factoring in ambient noise, such as sirens, which can provide additional context for assessing the behavior of a vehicle. For example, if sirens are activated, the system can anticipate that the vehicle may behave assertively and potentially erratic, albeit purposefully. Recognizing this, the system would adjust its own driving behavior accordingly.

According to an embodiment of the system, the host vehicle is further configured to detect whether the target vehicle is under autonomous control, semi-autonomous control, or human control. According to an embodiment of the system, the host vehicle is further configured to detect a driving behavior pattern of the target vehicle over a period of time. According to an embodiment of the system, the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining lane change distances for the host vehicle. According to an embodiment of the system, the host vehicle forms a virtual lasso with the target vehicle based on the first identity of the target vehicle. According to an embodiment of the system, the host vehicle determines a communication protocol based on the first identity of the target vehicle and sets the communication protocol to communicate with the target vehicle. According to an embodiment of the system, the host vehicle determines the payload content of a vehicle-to-vehicle message based on the first identity of the target vehicle. According to an embodiment of the system, the host vehicle determines a capability of the target vehicle based on the first identity of the target vehicle, wherein the capability comprises one or more of a braking distance, turn radius, maneuver capability, and safety features. According to an embodiment of the system, the host vehicle requests via the communication module a current condition of the target vehicle, wherein the current condition comprises one or more of a load condition, and a tire pressure of the target vehicle.

In an embodiment, in V2V communication with vehicles on the road, for example, Volvo® is talking to Volvo® versus Volvo® is talking to some other company vehicle, there may be differences in the features or availability or accessibility of different fields within V2V.

Ideally, if all manufacturers of the vehicles shared their specifications for each function, including specific numerical values, there would still likely be differences. For instance, the detection range or the manner in which warnings are issued to the driver, or even the extent of intervention in driver activities can vary significantly. Some Original Equipment Manufacturers (OEMs) may even implement restrictions, such as preventing lane changes when another vehicle is detected nearby. Therefore, the existence, features, and detailed specifications of each function in V2V communication may be heavily influenced by the brand. While some functions may be more generic, which operate uniformly across vehicles and regions, many advanced functions exhibit brand-specific nuances.

In an embodiment, the system is configured for i) identifying the advanced features that are installed in the target system and ii) identifying the advanced features that are activated. For example, the vehicle's brand may offer twenty features to a customer, who chooses to opt for purchasing and installing ten features and activating five of them.

In an embodiment, the system determines which features are actually installed via a V2V communication or via a database. In an embodiment, the features that are activated may be detected based on a visual signal, like the Blind Spot Information System (BLIS) indication. While the host vehicle may try to detect the BLIS signal, it might not be easily visible from a distance or under certain weather conditions. In such cases, a V2V communication may be utilized. In an embodiment, alternative methods are used for identifying activated features when visual confirmation is challenging, for example, using V2V communication directly with the target vehicle or via another vehicle that has a better view of the target vehicle.

In an embodiment, when either visual detection or V2V does not confirm the safety feature availability, then the system would be considering the worst-case scenario or most conservative assumption. For instance, when there is a lack of knowledge about a driver's behavior, the system may by default assume they may behave unpredictably. Similarly, if there is a lack of confirmation that a specific function is always activated in a particular vehicle, the system then assumes that it is deactivated. This assumption aligns with a futuristic trend where gradually, with increased trust in automated systems, the regulatory systems may mandate certain functions as essential and permanently activated. For instance, like airbags, which are typically not de-activatable for the driver's safety.

In an embodiment, if a function is mandated by regulations, such as to not abruptly change lanes, the system may not explicitly account for this. It may then become a standard behavior expected of all vehicles, guided by regulations. Therefore, the system in such cases or scenarios may safely assume such functions are activated in all vehicles subject to the regulations of the jurisdiction in which they operate.

For example, consider the case of police vehicles with small LEDs on their exterior mirrors. While a driver may easily notice these with sharp eyes, current camera systems might struggle. In an embodiment, the system may consider sensor fusion of data from a plurality of sensors to detect more accurately. In an embodiment, cameras are enabled for zooming in on specific areas of interest, allowing for feature detection. Additionally, future improvements in camera resolution could also enhance the detection of activated features. In a worst-case scenario, if a feature activation cannot be confirmed, it is assumed that it is inactive.

As for alternative methods, one possibility is to establish communication between vehicles via V2V. For example, a Volvo® could communicate with a BMW®, exchanging information about activated features. This could be facilitated by initiating a call between the vehicles, wherein they exchange lists of activated functions. This information can then be utilized to adjust trajectory calculations. It is important to recognize that the assessment of trustworthiness or confidence level is not binary but rather exists on a spectrum. A wide margin of caution may be incorporated for vehicles with unknown or unreliable features, while a more nuanced approach may be appropriate for vehicles with varying levels of trustworthiness.

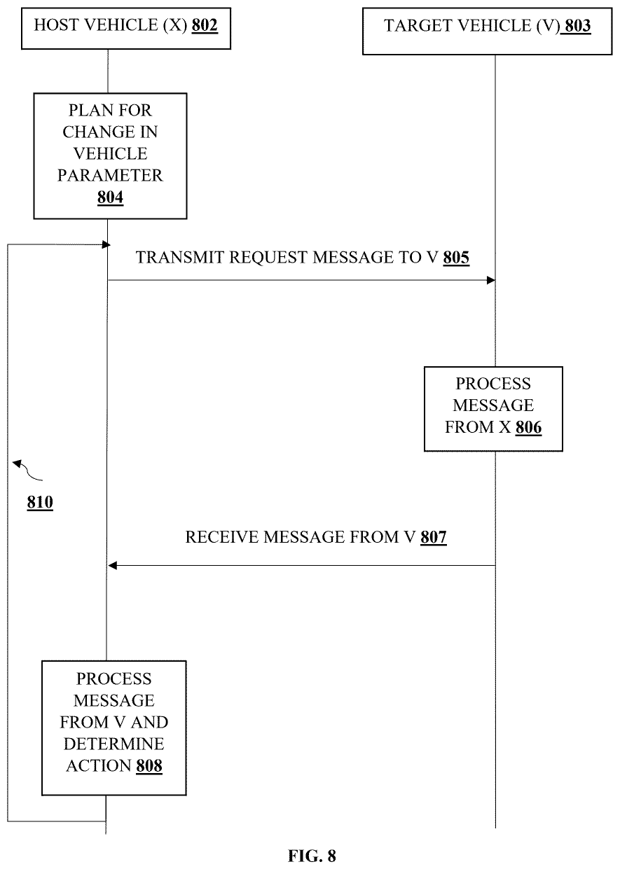

FIG. 8 shows communication between a host vehicle and a target vehicle according to an embodiment. The host vehicle, upon detecting a target vehicle along its path may try to detect a characteristic of the target vehicle. It may identify the brand, make, and model from image processing of the real-time images or video captured by the vision system of the host vehicle. The host vehicle 802 may communicate via V2V communication with the target vehicle 803 with a request message asking to identify the target vehicle's brand, make, and model at 805. The request may be initiated after the host vehicle plans for a change in vehicle parameter at 804 such as speed, lane change, etc. The target vehicle may process the message at 806 and transmit the details as per requested message. The host vehicle receives the message at 807 and processes it to identify an action 808, for example to cross check the brand, model, and make. Based on the match between the visually identified information and the V2V message the host vehicle determines if the information is correct or if there is a concern. When there is a mismatch between visual identification details and the V2V message information that is received in terms of brand, there are two actions that will be considered. First, to verify the confidence level on the visual identification of the brand, and second, based on the confidence level, whether there is a security threat with the target vehicle. If the visual identification information is of high confidence, then a cybersecurity issue will be raised and broadcasted to surrounding vehicles. If the visual identification information is of less confidence, then the V2V information will be used to learn and refine the AI/ML identification algorithm.

Further, based on the brand, if the host vehicle could not retrieve the safety features, the communication module may send one more request querying the safety features that are enabled in the target vehicle. The target vehicle may receive the information about the safety features active on the target system and whether the target system is in autonomous mode or in the driver mode. In an embodiment, the system may receive the safety features available and safety features active. In an embodiment, the host vehicle and the target vehicle communicate by transmitting and receiving messages in series as shown at 810, based on the information received and information processed until the host vehicle has information to determine its path and to avoid any collision or safety issue. This communication may happen with one or more target vehicles that are relevant for the path prediction of the host vehicle.

Example request message from host vehicle to target vehicle, when the host vehicle plans for a change in its behavior/vehicle parameter, may include request for one or more of identification details, registration details, brand, make, model. Once the information is received from the target vehicle, the host vehicle may process to find the capabilities of the target vehicle. It may comprise safety features that are enabled.

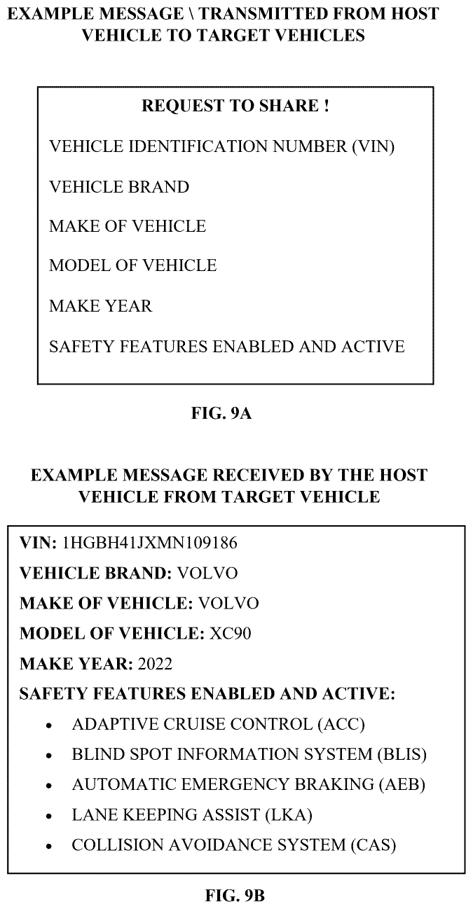

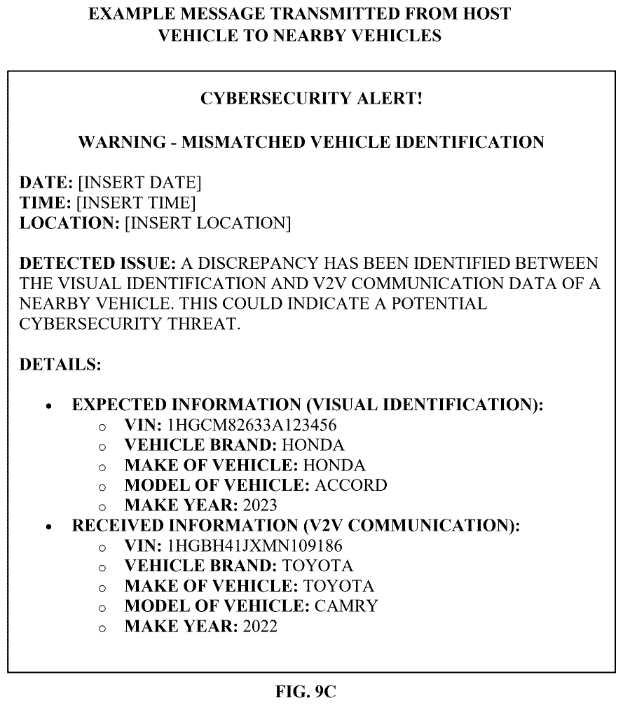

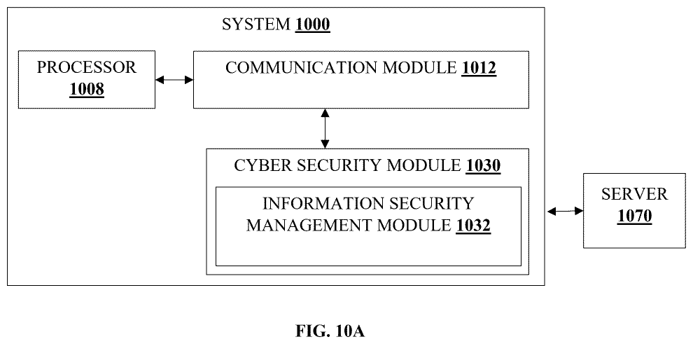

FIG. 9A shows an example message transmitted by the host vehicle to the target vehicle according to an embodiment. The message transmitted may comprise a request to share the target vehicle details. Target vehicle details may comprise one or more of vehicle identification number, vehicle brand, make of the vehicle, model of the vehicle, make year, and safety features enabled and active. Upon receiving the request, the target vehicle may process the message and transmit a message comprising vehicle details which is shown in FIG. 9B. FIG. 9B shows an example message received by the target vehicle from the host vehicle according to an embodiment. It may comprise all the requested details or part of the requested details. It may comprise one or more of vehicle identification number, vehicle brand, make of the vehicle, model of the vehicle, make year, and safety features enabled and active. The safety features may be a list of all the activated safety features such as Adaptive Cruise Control (ACC); Blind Spot Information System (BLIS); Automatic Emergency Braking (AEB); Lane Keeping Assist (LKA); Collision Avoidance System (CAS) etc. This list and terminology may change based on the brand and model. The list may be kept as a standard list and the features may be mapped on to the standard list via yes or no options for easy understanding of different terms used for the same functionality in different brands.

As mentioned herein in the description, when there is a mismatch between the visual detection and the V2V communication information from the target vehicle, a cyber security alert may be raised with the information as shown in FIG. 9C. FIG. 9C shows an example message on cybersecurity alert on the target vehicle raised by the host vehicle according to an embodiment. It may comprise the details such as date, time, location, detected issue, and details of the detected issue.

Host Vehicle Adaptive Behavior Planning Module 216 aids the host vehicle in intelligently planning the behavior based on the brand and model of one or more target vehicles through vehicle-to-vehicle (V2V) communication and image processing. By recognizing the specific characteristics and capabilities of different vehicle brands and models, the host vehicle can adjust its driving strategy to enhance safety, efficiency, and comfort.

In an embodiment, vehicle behavior planning comprises one or more of a trajectory planning, coordination of movement, limiting the safe distances and planning how precautionary the host vehicle should drive based on the confidence level of the target vehicle.

The host vehicle can adjust the following distance knowing that the target vehicle has advanced safety features like automatic emergency braking which can allow the host vehicle to reduce its following distance safely. Based on the braking capabilities, for example, a sports vehicle with high-performance brakes, the host vehicle can follow more closely, while for a heavier truck with longer stopping distances, it should maintain a greater distance.

The host vehicle can perform the speed adjustments. Understanding the target vehicle's acceleration and speed capabilities helps in adjusting the host vehicle's speed to maintain a smooth flow of traffic. Further, if the target vehicle is known to have adaptive cruise control, the host vehicle can match its speed more accurately.

The host vehicle can determine the lane change decisions. Predictive models may aid in recognizing that a particular vehicle model is less likely to make sudden lane changes and can influence the host vehicle's lane change decisions, reducing the risk of collisions. Similarly, identifying emergency vehicles such as ambulances, police vehicles, or fire trucks allows the host vehicle to yield or change lanes to give way.

The host vehicle can determine the overtaking strategy. Based on the performance and driver behavior, if the target vehicle is a slower, less maneuverable model, the host vehicle can decide on a safer and quicker overtaking maneuver. Similarly, if the driver is behaving erratically, then the host vehicle can decide to be more conservative. Further, visually detecting the vehicle size and type and knowing the dimensions and type (e.g., commercial truck, compact car) aids in planning the overtaking path and timing.

The host vehicle, by understanding the capabilities of the target vehicles and likely behaviors of different vehicle brands and models, can make more informed decisions that minimize the risk of accidents. Advanced driver-assistance systems (ADAS) can better predict and react to the movements by considering the other vehicles' capabilities and thus leading to fewer collisions.

More accurate predictions about the movements of surrounding vehicles contribute to smoother traffic flow and reduced congestion. Further, intelligent speed and lane management based on real-time data will enhance overall traffic efficiency. Predictable and smooth driving adjustments reduce abrupt braking and acceleration, providing a more comfortable ride for passengers. Minimizing unnecessary lane changes and maintaining optimal following distances would further lead to smooth traffic flow. Maintaining steady speeds and reducing stop-and-go traffic through better vehicle behavior prediction can lead to lower fuel consumption. Efficient driving strategies based on the characteristics of nearby vehicles can optimize energy use, especially in electric or hybrid vehicles. By leveraging the data on vehicle brand and model, host vehicles equipped with advanced AI/ML based algorithms and sensors from vision systems can create a more responsive, intelligent, and adaptive driving experience. Integration of V2V communication and image processing technologies represents a significant advancement in the development of autonomous and semi-autonomous driving systems.

Host vehicle determines confidence level on the target vehicles based on real-time monitoring and based on the safety features enabled in the target vehicle. Confidence level on one or more vehicles is placed for real-time adaptive behavior planning during driving. It refers to the degree of trust or assurance that a self-driving vehicle assigns to other vehicles on the road, with this trust primarily influenced by the brand identity of those vehicles. Several factors that may be considered for determining confidence level and contribute to the host vehicle's decision-making process are i) Brand reputation: established brands known for safety and reliability generally evoke higher confidence compared to lesser-known or newer brands; (ii) Safety Features: presence and effectiveness of safety features, such as collision detection systems, automatic emergency braking, and lane-keeping assistance, i.e., vehicles equipped and enabled with advanced safety technologies inspire greater trust; (iii) Technological capabilities: vehicles with autonomous driving capabilities and advanced technologies for navigation, such as adaptive cruise control and lane centering, are viewed as more reliable, leading to higher confidence levels; (iv) Performance history: historical data on the performance and safety record of vehicles from different brands influence confidence levels. Vehicles with a history of accidents or technical issues may be viewed with caution, while those with a proven record inspire more trust; v) Regulatory compliance: compliance with safety regulations and industry standards enhances confidence levels. Vehicles that meet or exceed safety requirements are perceived as safer and more trustworthy; vi) Erratic behavior: factors such as erratic driving behavior or sudden maneuvers may lower their confidence levels.

Continuous monitoring of real-time data and feedback from sensors, cameras, and other sources allows self-driving vehicles to assess the behavior of surrounding vehicles and adjust confidence levels accordingly. These factors are considered in real-time, and the host vehicle can dynamically adjust its behavior and decision-making processes, such as lane changes, merging, and following distances, to ensure safe navigation in traffic environments. In an embodiment, assignment of a confidence score explicitly is an optional step as long as a trust parameter is impliedly considered in decision making of the host vehicle for its behavior based on the data from the sensors of the host vehicle and the communication from the target vehicle.

Databases 218 is configured to manage large volumes of information efficiently, allowing system/users to perform various operations such as storing, retrieving, updating, and deleting data. They are structured to facilitate data management and are typically used by applications to handle complex datasets in a systematic way. The system stores various types of data that can be stored in a database for processing, analysis, and future reference. This comprises storing raw image data captured by the sensors. Additionally, metadata about detected objects such as type, location within the image frame, size, and confidence scores from object detection algorithms can be recorded. Target vehicle data such as model, make, year of make, safety features that are available, installed, and activated, its predicted behavior, and any other data, alongside any associated metadata, is also stored. Furthermore, the system logs important events such as object detections, target vehicle identifications, for performance monitoring and issue resolution. Configuration settings, like camera calibration parameters are stored to ensure consistent system behavior. The database's role extends to efficient data retrieval, analysis for insights such as user behavior trends, and facilitating data management tasks like cleaning and security measures such as access control and encryption. In an embodiment, the database may serve as a repository. Portions of data may be stored temporarily, and portions of data may be stored for long term. In an embodiment, data of a trip comprising starting location, ending location, host vehicle planned behavior, list of target vehicles detected along with their make, model, predicted path, errors made in prediction, etc., are all stored in the database. The databases are located locally, in a cloud, and/or combination of local and cloud.

Cybersecurity Module 220 is configured to detect and recommend an action to resolve or take care of the scenario in case of a cybersecurity issue. A cybersecurity alert message may be generated from the cybersecurity module and may comprise a list of potential risks and recommended actions.

Potential risks may include a malicious actor may be attempting to spoof vehicle information; the V2V communication data may have been compromised and thus data tampering risk; and there could be a system malfunction in either the visual identification system of the host vehicle or the V2V communication module or the target vehicle.

Some of the recommended actions include to Conduct a third verification of the vehicle's identity; Notify relevant authorities or cybersecurity teams to investigate the issue; Notify the target vehicle itself to check the issue in V2V communication; Exercise increased caution and maintain a safe distance from the identified vehicle; Document the incident with all available data for further analysis; and Identify a contact information for further assistance on the cybersecurity issue resolution.

In an embodiment, the system 1000 may comprise a cyber security module 1030. In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

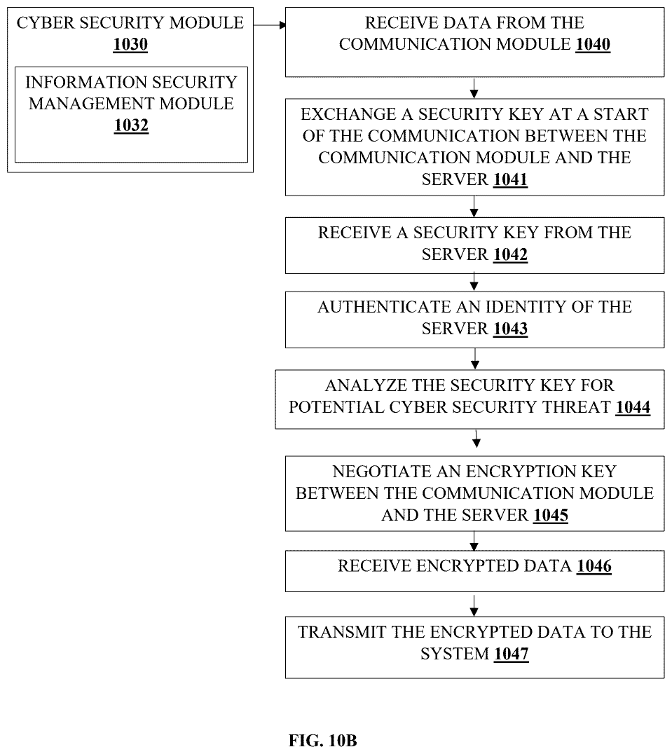

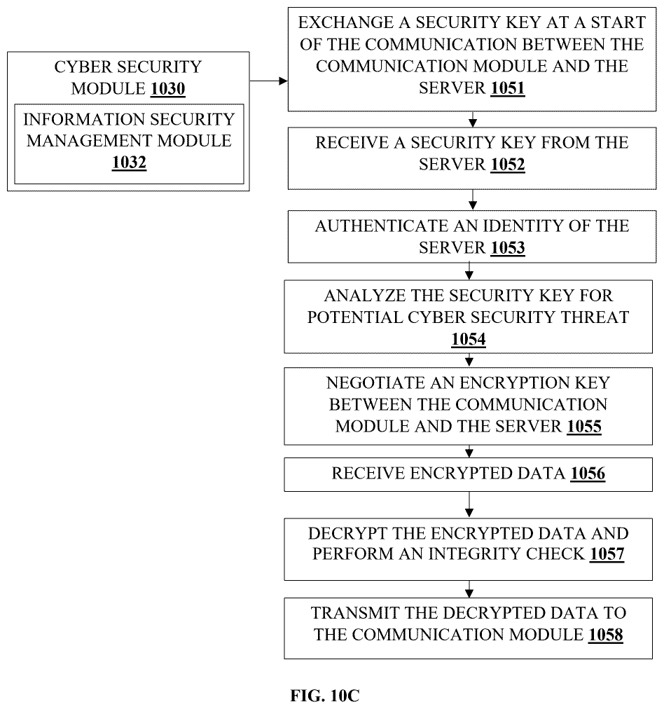

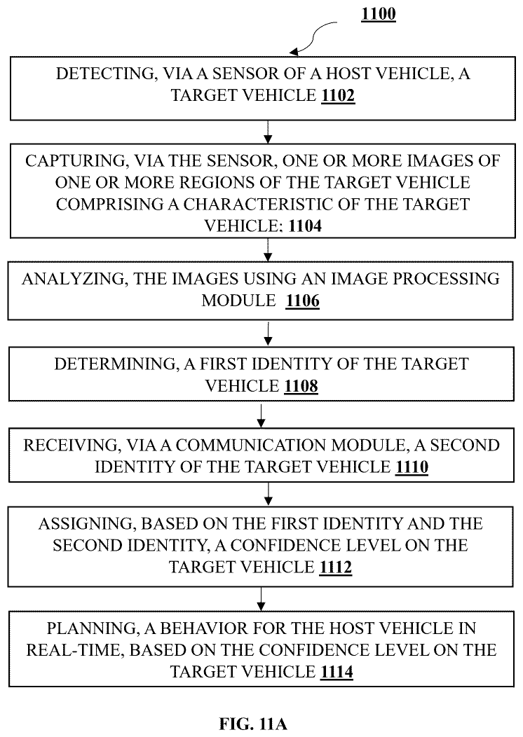

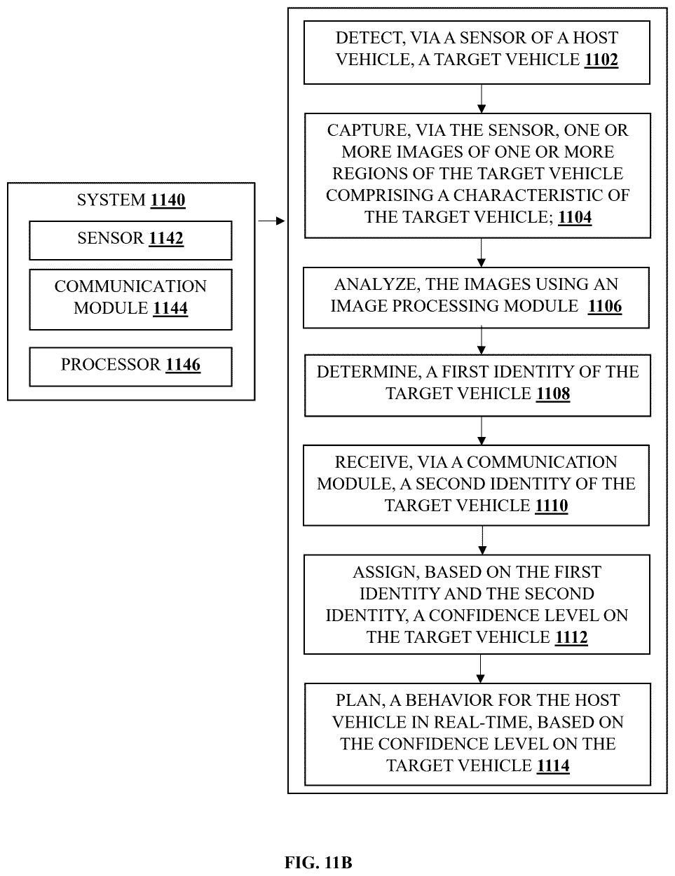

FIG. 10A shows the block diagram of the cyber security module 1030 in view of the system and server according to an embodiment. The communication of data between processor 1008 of system 1000 and the server 1070 through the communication module 1012 is first verified by the information security management module 1032 before being transmitted from the system to the server or from the server to the system. Cyber security module 1030 comprises information security management module 1032. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 10B shows a block diagram of the cyber security module configured for checking a cybersecurity threat according to an embodiment. In an embodiment, the system comprises methods for securing the data through the cyber security module 1030. The information security management module 1032 is operable to receive data from the communication module 1040, exchange a security key at the start of the communication between the communication module and the server at step 1041, receive a security key from the server at step 1042, authenticate an identity of the server by verifying the security key at step 1043, analyze the security key for potential cyber security threats at step 1044, negotiate an encryption key between the communication module and the server at step 1045, receive the encrypted data at step 1046, and transmit the encrypted data to the server when no cyber security threat is detected at step 1047.

In an embodiment, the system comprises decryption of data by the cyber security module according to an embodiment. FIG. 10C shows a block diagram of the cyber security module configured for checking a cybersecurity threat according to an embodiment. In an embodiment, the system comprises methods for securing the data through the cyber security module 1030. The information security management module 1032 is operable to receive data from the communication module, exchange a security key at a start of the communication between the communication module and the server at step 1051, receive a security key from the server at step 1052, authenticate an identity of the server by verifying the security key at step 1053, analyze the security key for potential cyber security threats at step 1054, negotiate an encryption key between the communication module and the server at step 1055, receive encrypted data at step 1056, decrypt the encrypted data and perform an integrity check of the decrypted data at step 1057, and transmit the decrypted data to the communication module when no cyber security threat is detected at step 1058.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module. In an embodiment, the server is physically isolated from the system through the information security management module. When the system communicates with the server as shown in FIG. 10, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model. The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

Display module 222: The system would share information received via the communication module on the display. Any incoming messages, warnings, or any other important parameter related to the host vehicle are displayed on the display module 222. In an embodiment, a predicted path along with other vehicle possible paths may be displayed on the display module.

According to an embodiment, disclosed is a system for real-time vehicle identification to enable adaptive behavior in self-driving vehicles, comprising a vision system comprising one or more cameras configured to capture images of surrounding vehicles; a processing unit configured to receive and process the images captured by the vision system; a feature extraction module within the processing unit configured to analyze the images to identify distinctive features of the surrounding vehicles, including vehicle brand, make, and model; a database storing data on various vehicle brands, makes, and models, including their respective capabilities and behavior profiles; an identification module within the processing unit configured to compare the extracted features with the data stored in the database to determine the identity and capabilities of the surrounding vehicles; a communication module configured to receive additional information from surrounding vehicles via vehicle-to-vehicle (V2V) communication; an adaptive behavior module within the processing unit configured to adjust the self-driving vehicle's behavior based on the identified capabilities and behavior profiles of the surrounding vehicles, ensuring safe and efficient navigation; a decision-making and planning module configured to integrate information from the adaptive behavior module and generate appropriate driving maneuvers for the self-driving vehicle.

In an embodiment, the vision system further comprises sensors such as radar and LIDAR to complement the image data and provide a comprehensive view of the surrounding environment.

In an embodiment, the feature extraction module utilizes machine learning algorithms, including convolutional neural networks (CNNs), to improve the accuracy of vehicle identification and feature extraction.

In an embodiment, the communication module is configured to transmit and receive data using vehicle-to-everything (V2X) communication protocols, including V2V and vehicle-to-infrastructure (V2I) communications.

In an embodiment, the adaptive behavior module is configured to adjust the self-driving vehicle's speed, following distance, and lane position based on the detected capabilities and anticipated behaviors of the surrounding vehicles.

In an embodiment, the decision-making and planning module further incorporates historical data and predictive models to anticipate potential maneuvers of the surrounding vehicles and plan preemptive actions to avoid collisions and ensure smooth traffic flow.

In an embodiment, the processing unit is further configured to continuously update the vehicle's situational awareness by integrating real-time data from the vision system, communication module, and other onboard sensors.

In an embodiment, the adaptive behavior module further comprises a learning mechanism to adapt to new behaviors and capabilities of vehicles as they are encountered, improving the system's performance over time.

Business Problem: The business problem addressed by this invention is the need for enhanced safety and reliable communication between vehicles on the road. This issue is critical for ensuring road safety and efficient traffic management. Currently, the inability to accurately detect and respond to the capabilities of nearby vehicles can lead to accidents, inefficiencies, and a lack of trust in autonomous driving technologies. Thus, a system that improves vehicle identification and communication is essential to mitigate these risks and enhance the overall safety and efficiency of road transport.

Technical Problem: The technical challenges in the current state of the art include inadequate methods for vehicle identification, limited V2V communication protocols, and inconsistent data between visual identification and V2V communication. These limitations prevent vehicles from reliably distinguishing between different brands and models, understanding specific capabilities and safety features, and responding appropriately to real-time traffic conditions. Moreover, potential cybersecurity risks further complicate the reliable operation of autonomous vehicles.

Business Solution: The proposed business solution involves implementing a system that comprises vehicle identification based on visual identification methods and/or V2V communication. This system aims to improve road safety by ensuring that vehicles can accurately identify vehicle's brand and their respective capabilities. It enables autonomous vehicles to make informed decisions based on the detected safety features of surrounding vehicles, thereby increasing trust in autonomous driving systems. Additionally, the solution addresses potential cybersecurity threats, ensuring consistent data integrity and reducing the likelihood of accidents and inefficiencies.

Technical Solution: The technical solution includes several innovative components and processes. These include an enhanced vision system utilizing advanced image processing techniques to accurately detect vehicle brands, models, and active safety features. Improved V2V communication protocols are augmented to provide detailed information about vehicle identity and capabilities. Adaptive safety zones are implemented to maintain safe distances based on detected capabilities and real-time data. Furthermore, cybersecurity measures are integrated to detect and respond to discrepancies between visual identification and V2V communication data, mitigating potential spoofing and data tampering risks.

Technical Result: The technical solution achieves significant improvements, such as enhanced accuracy in vehicle identification, leading to better decision-making by autonomous systems. It also increases the reliability of V2V communication for providing comprehensive data about vehicle capabilities. Improved road safety may be possible through adaptive safety zones and proactive responses to potential threats.

Technical Details Specific to the Technical Solution: The technical aspects of the invention involve several key components. Advanced image processing techniques like edge detection, key point detection, color and texture analysis, and deep learning models are used to accurately identify vehicle characteristics such as brands, models, and safety features enabled. Enhanced V2V communication protocols transmit detailed vehicle information, including make, model, safety features, and operational statuses. Adaptive safety zone algorithms dynamically adjust safety zones based on real-time data from visual and V2V sources. A robust cybersecurity framework is implemented to compare and verify visual identification data against V2V communication and detect inconsistencies.

How Technical Solution is a Technological Advancement: This technical solution represents a technological advancement over current technologies by combining advanced image processing with improved V2V communication to provide a vehicle characteristics identification and enabled safety features. It introduces adaptive safety zones that respond to real-time data based on vehicle characteristics and safety features that are enabled, for enhancing road safety. The technological solution further comprises cybersecurity measures protects against data discrepancies and potential threats and thus improvement in autonomous vehicles trajectory planning.

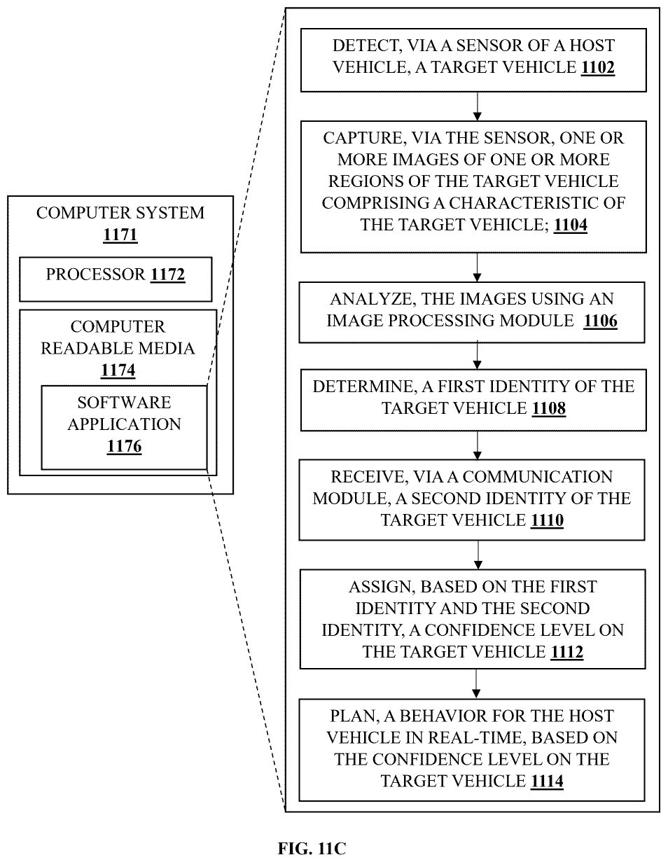

FIG. 11A shows a block diagram of the method 1100 executed by the vehicle for real-time vehicle identification for adaptive behavior in self-driving vehicles according to an embodiment. According to an embodiment, disclosed is a method 1100 comprising, detecting, via a sensor of a host vehicle, a target vehicle at step 1102; capturing, via the sensor, one or more images of one or more regions of the target vehicle comprising a characteristic of the target vehicle at step 1104; analyzing, the images using an image processing module at step 1106; determining, a first identity of the target vehicle at step 1108; receiving, via a communication module, a second identity of the target vehicle at step 1110; assigning, based on the first identity and the second identity, a confidence level on the target vehicle at step 1112; and planning, a behavior for the host vehicle in real-time, based on the confidence level on the target vehicle at step 1114; and wherein the method is configured for adaptive behavior based on the first identity.

According to an embodiment of the method, the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distance for the host vehicle.

FIG. 11B shows a block diagram of the system of a vehicle for real-time vehicle identification for adaptive behavior in self-driving vehicles according to an embodiment. According to an embodiment, disclosed is a system 1140 comprising, a sensor 1142, a communication module 1144, and a processor 1146, wherein the processor storing instructions in a non-transitory memory that, when executed, cause the processor 1146 to detect, via the sensor of a host vehicle, a target vehicle at step 1102; capture, via the sensor, one or more images of one or more regions of the target vehicle comprising a characteristic of the target vehicle at step 1104; analyze, the images using an image processing module at step 1106; determine, a first identity of the target vehicle at step 1108; receive, via the communication module, a second identity of the target vehicle at step 1110; assign, based on the first identity and the second identity, a confidence level on the target vehicle at step 1112; and plan, a behavior for the host vehicle in real-time, based on the confidence level on the target vehicle at step 1114; and wherein the system is configured for adaptive behavior based on the first identity.

According to an embodiment of the system, the target vehicle is detected by receiving a signal transmitted by the target vehicle. According to an embodiment of the system, the confidence level is high when details of the first identity and the second identity match.

FIG. 11C shows a block diagram of the method executed by the non-transitory computer-readable medium for real-time vehicle identification for adaptive behavior in self-driving vehicles according to an embodiment. According to an embodiment, disclosed is a non-transitory computer-readable medium having stored thereon instructions executable by a computer system 1171 to perform operations comprising: detecting, via a sensor of a host vehicle, a target vehicle at step 1102; capturing, via the sensor, one or more images of one or more regions of the target vehicle comprising a characteristic of the target vehicle at step 1104; analyzing, the images using an image processing module at step 1106; determining, a first identity of the target vehicle at step 1108; receiving, via a communication module, a second identity of the target vehicle at step 1110; assigning, based on the first identity and the second identity, a confidence level on the target vehicle at step 1112; and planning, a behavior for the host vehicle in real-time, based on the confidence level on the target vehicle at step 1114; and wherein the instructions are configured for adaptive behavior based on the first identity. A software application 1176 may be stored on the computer-readable medium 1174 and executed with processor 1172 of the computer system 1171.

According to an embodiment of the non-transitory computer-readable medium, the sensor comprises one or more of an image sensor, a light detection and ranging sensor, a radio detection and ranging sensor, an ultrasonic sensor, a microphone, and an infrared sensor. According to an embodiment of the non-transitory computer-readable medium, the characteristic comprises one or more of a logo, a registration plate, a tail lamp, a shape of the target vehicle, and a size of the target vehicle. According to an embodiment of the non-transitory computer-readable medium, data generated is stored in a database. According to an embodiment of the non-transitory computer-readable medium, based on one or more of the first identity and the second identity, determine one or more safety features of the target vehicle, wherein the safety features comprise predictive navigation, collision warning systems, blind spot warning systems, and cross-traffic alert systems.

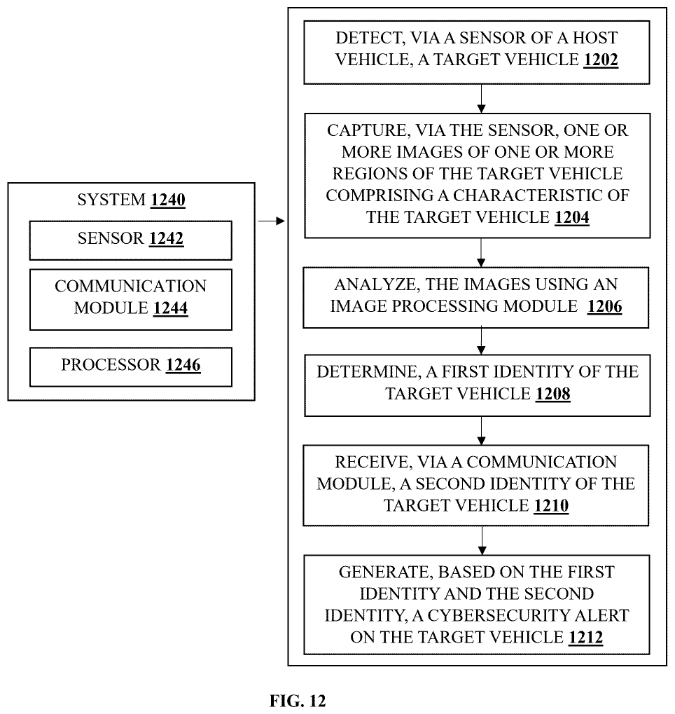

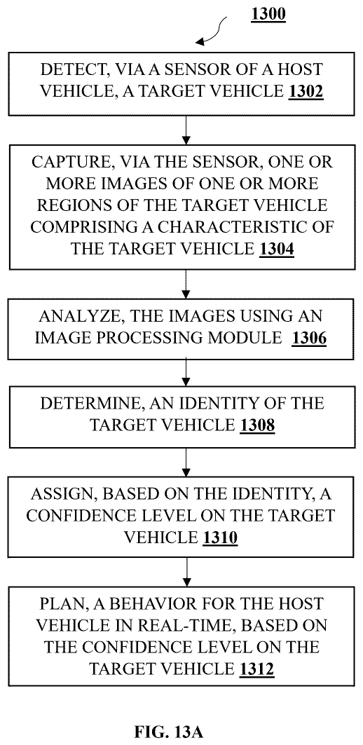

FIG. 12 shows a block diagram of the system of vehicle for real-time vehicle identification for adaptive behavior in self-driving vehicles according to an embodiment. According to an embodiment, it is a system 1240 comprising, a sensor 1242, a communication module 1244, and a processor 1246, wherein the processor 1246 storing instructions in a non-transitory memory that, when executed, cause the processor to: detect, via the sensor of a host vehicle, a target vehicle at step 1202; capture, via the sensor, one or more images of one or more regions of the target vehicle comprising a characteristic of the target vehicle at step 1204; analyze, the image using an image processing module at step 1206; determine, a first identity of the target vehicle at step 1208; receive, via the communication module, a second identity of the target vehicle at step 1210; generate, based on the first identity and the second identity, a cybersecurity alert on the target vehicle at step 1212.

According to an embodiment of the system, the sensor comprises one or more of an image sensor, a light detection and ranging sensor, a radio detection and ranging sensor, an ultrasonic sensor, a microphone, and an infrared sensor. According to an embodiment of the system, the characteristic comprises one or more of a logo, a registration plate, a tail lamp, a shape of the target vehicle, and a size of the target vehicle.

According to an embodiment of the system, the first identity and the second identity comprise one or more of a brand, a model, and a make.

According to an embodiment of the system, the cybersecurity alert comprises transmitting a message to neighboring vehicles comprising details of the target vehicle and data integrity issues in vehicle-to-vehicle communication with the target vehicle. According to an embodiment of the system, the cybersecurity alert comprises alerting the target vehicle on data integrity.

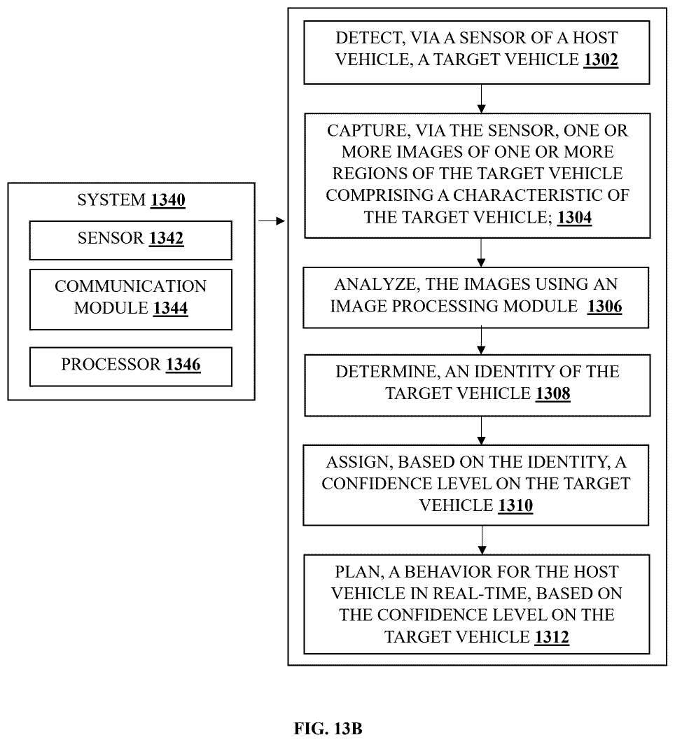

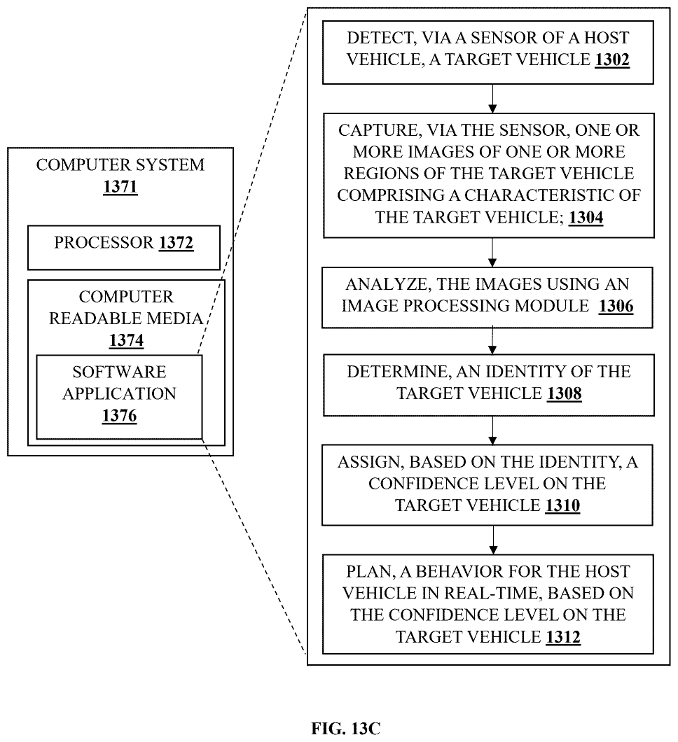

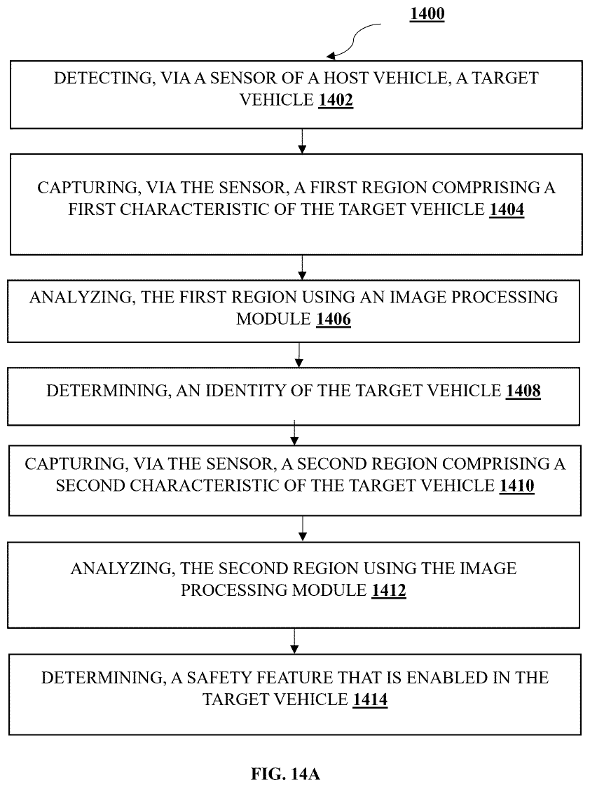

FIG. 13A shows a block diagram of the method of vehicle for real-time vehicle identification for adaptive behavior in self-driving vehicles according to an embodiment. According to an embodiment, disclosed is a method 1300 comprising detecting, via the sensor of a host vehicle, a target vehicle at step 1302; capturing, via the sensor, one or more images of one or more regions comprising a characteristic of the target vehicle at step 1304; analyzing, the image using an image processing module at step 1306; determining, an identity of the target vehicle at step 1308; assigning, based on the identity, a confidence level on the target vehicle at step 1310; and planning, a behavior for the host vehicle in real-time, based on the confidence level on the target vehicle at step 1312; and wherein the method is configured for adaptive behavior based on the identity.

FIG. 13B shows a block diagram of the system of a vehicle for real-time vehicle identification for adaptive behavior in self-driving vehicles according to an embodiment. According to an embodiment, disclosed is a system 1340 comprising, a sensor 1342, a communication module 1344, and a processor 1346, wherein the processor 1346 storing instructions in a non-transitory memory that, when executed, cause the processor to detect, via the sensor of a host vehicle, a target vehicle at step 1302; capture, via the sensor, one or more images of one or more regions comprising a characteristic of the target vehicle at step 1304; analyze, the image using an image processing module at step 1306; determine, an identity of the target vehicle at step 1308; assign, based on the identity, a confidence level on the target vehicle at step 1310; and plan, a behavior for the host vehicle in real-time, based on the confidence level on the target vehicle at step 1312; and wherein the system is configured for adaptive behavior based on the identity of the target vehicle.

According to an embodiment of the system, the sensor comprises one or more of an image sensor, a light detection and ranging sensor, a radio detection and ranging sensor, an ultrasonic sensor, a microphone, and an infrared sensor. According to an embodiment of the system, the microphone captures a sound signature of the target vehicle.

According to an embodiment of the system, the characteristic comprises one or more of a logo, a registration plate, a tail lamp, a shape of the target vehicle, and a size of the target vehicle. According to an embodiment of the system, the identity comprises one or more of a brand, a model, and a make.

According to an embodiment of the system, the system predicts the movement of the target vehicle based on the identity and the confidence level. According to an embodiment of the system, the system determines a protocol of the target vehicle based on the identity and the confidence level. According to an embodiment of the system, the host vehicle further analyzes the target vehicle for erratic behavior and a reason for the erratic behavior, wherein the reason comprises one or more of driver behavior and emergency. According to an embodiment of the system, the system further determines that the target vehicle is one of a police vehicle, an ambulance, a law enforcement vehicle, an emergency vehicle, an erratic vehicle, a heavy vehicle, and a regular vehicle. According to an embodiment of the system, the system further connects with a database comprising a mapping of the characteristic and various brands.

FIG. 13C shows a block diagram of the method executed by the non-transitory computer-readable medium for a vehicle for real-time vehicle identification for adaptive behavior in self-driving vehicles according to an embodiment. According to an embodiment, disclosed is a non-transitory computer-readable medium 1374 having stored thereon instructions executable by a computer system 1371 to perform operations comprising: detecting, via the sensor of a host vehicle, a target vehicle at step 1302; capturing, via the sensor, one or more images of one or more regions comprising a characteristic of the target vehicle at step 1304; analyzing, the image using an image processing module at step 1306; determining, an identity of the target vehicle at step 1308; assigning, based on the identity, a confidence level on the target vehicle at step 1310; and planning, a behavior for the host vehicle in real-time, based on the confidence level on the target vehicle at step 1312. A software application 1376 may be stored on the computer-readable medium 1374 and executed with processor 1372 of the computer system 1371; and wherein the instructions are configured for adaptive behavior based on the identity.

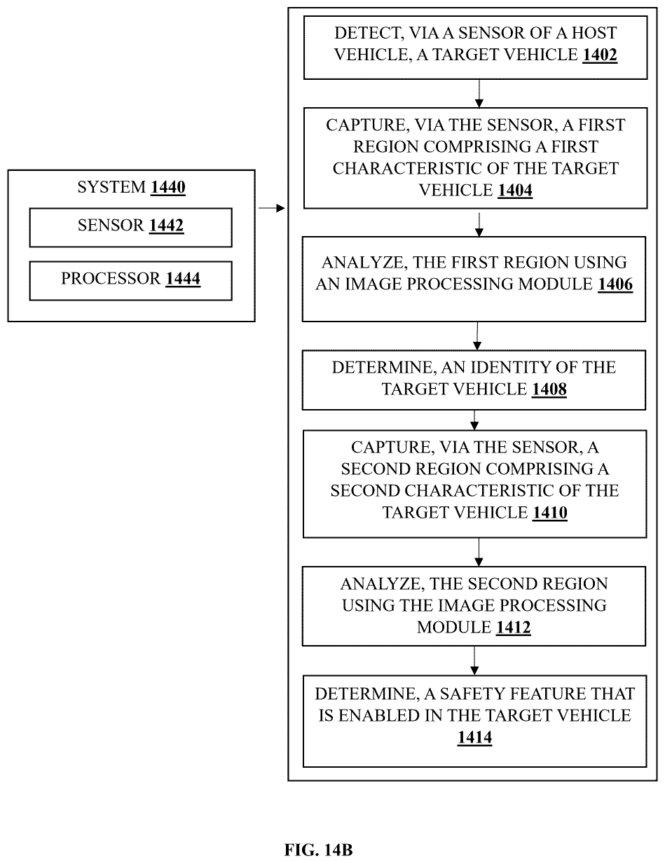

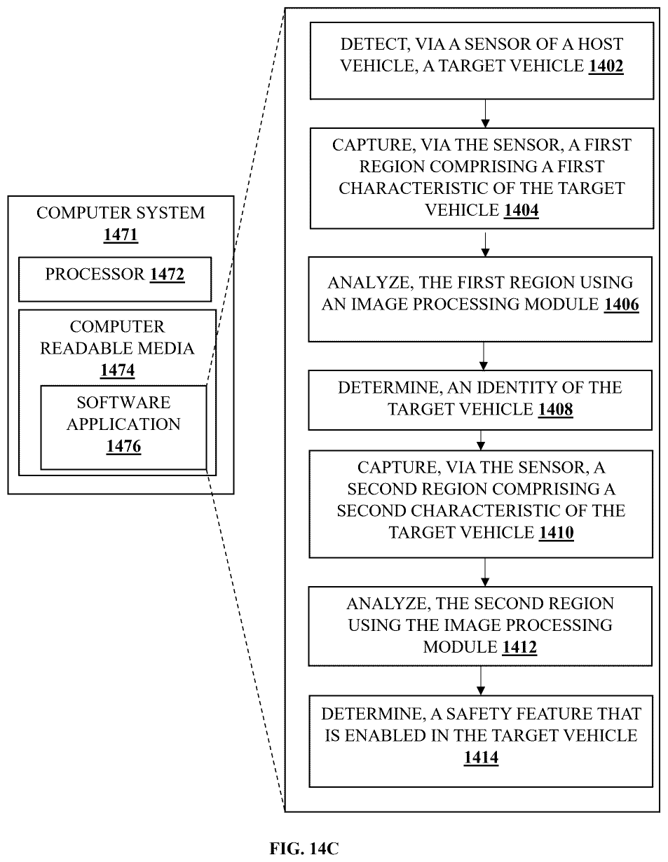

FIG. 14A shows a block diagram of the method executed by the vehicle for determining a safety feature enabled in a vehicle according to an embodiment. According to an embodiment disclosed is a method 1400 comprising, detecting, via a sensor of a host vehicle, a target vehicle at step 1402; capturing, via the sensor, a first region comprising a first characteristic of the target vehicle at step 1404; analyzing, the first region using an image processing module at step 1406; determining, an identity of the target vehicle at step 1408; capturing, via the sensor, a second region comprising a second characteristic of the target vehicle at step 1410; analyzing, the second region using the image processing module at step 1412; and determining, a safety feature that is enabled in the target vehicle at step 1414.

According to an embodiment of the method, the sensor comprises one or more of an image sensor, a light detection and ranging, a radio detection and ranging, an ultrasonic sensor, a microphone, and an infrared sensor.

According to an embodiment of the method, the first characteristic comprises one or more of a logo, a registration plate, a tail lamp, a shape of the target vehicle, and a size of the target vehicle. According to an embodiment of the method, the identity comprises one or more of a brand, a model, and a make. According to an embodiment of the method, the second characteristic comprises a visual display of a safety feature in the target vehicle.

According to an embodiment of the method, the safety feature comprises one or more of lane keeping assist, blind spot information system, cross traffic alert, driver alert control, run-off road mitigation, collision avoidance assist, automatic emergency braking, electronic stability control, 360-degree camera system, and pilot assist.

According to an embodiment of the method, the method further comprises assigning a confidence level on the target vehicle based on the identity and the safety feature. According to an embodiment of the method, the method further comprises planning a behavior for the host vehicle in real-time based on the confidence level on the target vehicle.

According to an embodiment of the method, the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distance for the host vehicle.

FIG. 14B shows a block diagram of the system of vehicle for determining a safety feature enabled in a vehicle according to an embodiment. According to an embodiment, disclosed is a system 1440 comprising, a sensor 1442 and a processor 1444; wherein the processor 1444 storing instructions in a non-transitory memory that, when executed, cause the processor to: detect, via the sensor of a host vehicle, a target vehicle at step 1402; capture, via the sensor, a first region comprising a first characteristic of the target vehicle at step 1404; analyze, the first region using an image processing module at step 1406; determine, an identity of the target vehicle at step 1408; capture, via the sensor, a second region comprising a second characteristic of the target vehicle at step 1410; analyze, the second region using the image processing module at step 1412; and determine, a safety feature that is enabled in the target vehicle at step 1414.

According to an embodiment of the system, the sensor comprises one or more of an image sensor, a light detection and ranging, a radio detection and ranging, an ultrasonic sensor, a microphone, and an infrared sensor. According to an embodiment of the system, the first characteristic comprises one or more of a logo, a registration plate, a tail lamp, a shape of the target vehicle, and a size of the target vehicle. According to an embodiment of the system, the identity comprises one or more of a brand, a model, and a make. According to an embodiment of the system, the second characteristic comprises a visual display of a safety feature in the target vehicle.

According to an embodiment of the system, the safety feature comprises one or more of lane keeping assist, blind spot information system, cross traffic alert, driver alert control, run-off road mitigation, collision avoidance assist, automatic emergency braking, electronic stability control, 360-degree camera system, and pilot assist. According to an embodiment of the system, the system further assigns, based on the identity and the safety feature, a confidence level on the target vehicle.

According to an embodiment of the system, the system further plans a behavior for the host vehicle in real-time, based on the confidence level on the target vehicle. According to an embodiment of the system, the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distance for the host vehicle.

FIG. 14C shows a block diagram of the method executed by the non-transitory computer-readable medium for determining a safety feature enabled in a vehicle according to an embodiment.

According to an embodiment, disclosed is a non-transitory computer-readable medium 1474 having stored thereon instructions executable by a computer system 1471 to perform operations comprising: detecting, via a sensor of a host vehicle, a target vehicle at step 1402; capturing, via the sensor, a first region comprising a first characteristic of the target vehicle at step 1404; analyzing, the first region using an image processing module at step 1406; determining, an identity of the target vehicle at step 1408; capturing, via the sensor, a second region comprising a second characteristic of the target vehicle at step 1410; analyzing, the second region using the image processing module at step 1412; and determining, a safety feature that is enabled in the target vehicle at step 1414. A software application 1476 may be stored on the computer-readable medium 1474 and executed with processor 1472 of the computer system 1471.

According to an embodiment of the non-transitory computer-readable medium, the sensor comprises one or more of an image sensor, a light detection and ranging, a radio detection and ranging, an ultrasonic sensor, a microphone, and an infrared sensor.

According to an embodiment of the non-transitory computer-readable medium, the first characteristic comprises one or more of a logo, a registration plate, a tail lamp, a shape of the target vehicle, and a size of the target vehicle. According to an embodiment of the non-transitory computer-readable medium, the identity comprises one or more of a brand, a model, and a make. According to an embodiment of the non-transitory computer-readable medium, the second characteristic comprises a visual display of the safety feature in the target vehicle.

According to an embodiment of the non-transitory computer-readable medium, the safety feature comprises one or more of lane keeping assist, blind spot information system, cross traffic alert, driver alert control, run-off road mitigation, collision avoidance assist, automatic emergency braking, electronic stability control, 360-degree camera system, and pilot assist. According to an embodiment of the non-transitory computer-readable medium, the instructions are configured to further assign a confidence level on the target vehicle based on the identity and the safety feature.

According to an embodiment of the non-transitory computer-readable medium, the instructions are configured to further plan a behavior for the host vehicle in real-time based on the confidence level on the target vehicle. According to an embodiment of the non-transitory computer-readable medium, the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distance for the host vehicle.

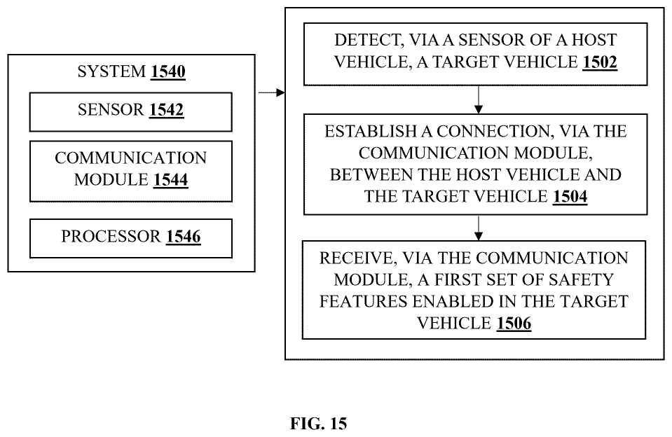

FIG. 15 shows a block diagram of the system of vehicle for determining a safety feature enabled in a vehicle according to an embodiment. According to an embodiment, disclosed is a system 1540 comprising, a sensor 1542, a communication module 1544, and a processor 1546; wherein the processor 1546 storing instructions in a non-transitory memory that, when executed, cause the processor to: detect, via the sensor of a host vehicle, a target vehicle at step 1502; establish a connection, via the communication module, between the host vehicle and the target vehicle at step 1504; and receive, via the communication module, a first set of safety features enabled in the target vehicle at step 1506.

According to an embodiment of the system, the sensor comprises one or more of an image sensor, a light detection and ranging, a radio detection and ranging, an ultrasonic sensor, a microphone, and an infrared sensor. According to an embodiment of the system, the first set of safety features comprise one or more of lane keeping assist, blind spot information system, cross traffic alert, driver alert control, run-off road mitigation, collision avoidance assist, automatic emergency braking, electronic stability control, 360-degree camera system, and pilot assist.

According to an embodiment of the system, the processor is configured to assign a confidence level on the target vehicle, based on the first set of safety features. According to an embodiment of the system, the processor is further configured to plan a behavior for the host vehicle in real-time, based on the confidence level on the target vehicle. According to an embodiment of the system, the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distance for the host vehicle.

According to an embodiment of the system, the system further detects an identity of the target vehicle via the sensor, wherein the identity comprises one or more of a brand, a model, and a make. According to an embodiment of the system, the system further determines based on the identity, a second set of safety features available in the target vehicle.

According to an embodiment of the system, the system further receives an identity of the target vehicle via the communication module, wherein the identity comprises one or more of a brand, a model, and a make.

According to an embodiment of the system, the system further determines, based on the identity, a second set of safety features available in the target vehicle. According to an embodiment of the system, the second set of safety features comprise one or more of lane keeping assist, blind spot information system, cross traffic alert, driver alert control, run-off road mitigation, collision avoidance assist, automatic emergency braking, electronic stability control, 360-degree camera system, and pilot assist.

According to an embodiment of the system, the communication module comprises a wireless connectivity module configured to establish communication with one or more external systems, networks, and devices via one or more wireless communication technologies. According to an embodiment of the system, the wireless communication technologies comprise one or more of Bluetooth, Wi-Fi, cellular network, near field communication, radio-frequency identification, Zigbee, Z-wave, Long Range Wide Area Network. According to an embodiment of the system, the communication module comprises security protocols configured for security and integrity of data transmitted over wireless networks.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-41. (canceled)

42. A system comprising,
a sensor and a processor;
wherein the processor storing instructions in a non-transitory memory that, when executed, cause the processor to:
detect, via the sensor of a host vehicle, a target vehicle;
capture, via the sensor, a first region comprising a first characteristic of the target vehicle;
analyze, the first region using an image processing module;
determine, an identity of the target vehicle;
capture, via the sensor, a second region comprising a second characteristic of the target vehicle;
analyze, the second region using the image processing module; and
determine, a safety feature that is enabled in the target vehicle; and
wherein the system is configured for real-time identification of the safety feature in the target vehicle for adaptive behavior of the host vehicle.

43. The system of claim 42, wherein the sensor comprises one or more of an image sensor, a light detection and ranging, a radio detection and ranging, an ultrasonic sensor, a microphone, and an infrared sensor.

44. The system of claim 42, wherein the first characteristic comprises one or more of a logo, a registration plate, a tail lamp, a shape of the target vehicle, and a size of the target vehicle.

45. The system of claim 42, wherein the identity comprises one or more of a brand, a model, and a make.

46. The system of claim 42, wherein the second characteristic comprises a visual display of the safety feature in the target vehicle.

47. The system of claim 42, wherein the safety feature comprises one or more of lane keeping assist, blind spot information system, cross traffic alert, driver alert control, run-off road mitigation, collision avoidance assist, automatic emergency braking, electronic stability control, 360-degree camera system, and pilot assist.

48. The system of claim 42, wherein the system further assigns, based on the identity and the safety feature, a confidence level on the target vehicle.

49. The system of claim 48, wherein the system further plans a behavior for the host vehicle in real-time, based on the confidence level on the target vehicle.

50. The system of claim 49, wherein the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distance for the host vehicle.

51. A method comprising,
detecting, via a sensor of a host vehicle, a target vehicle;
capturing, via the sensor, a first region comprising a first characteristic of the target vehicle;
analyzing, the first region using an image processing module;
determining, an identity of the target vehicle;
capturing, via the sensor, a second region comprising a second characteristic of the target vehicle;
analyzing, the second region using the image processing module; and
determining, a safety feature that is enabled in the target vehicle; and
wherein the method is configured for real-time identification of the safety feature in the target vehicle for adaptive behavior of the host vehicle.

52. The method of claim 51, wherein the sensor comprises one or more of an image sensor, a light detection and ranging, a radio detection and ranging, an ultrasonic sensor, a microphone, and an infrared sensor.

53. The method of claim 51, wherein the first characteristic comprises one or more of a logo, a registration plate, a tail lamp, a shape of the target vehicle, and a size of the target vehicle.

54. The method of claim 51, wherein the identity comprises one or more of a brand, a model, and a make.

55. The method of claim 51, wherein the second characteristic comprises a visual display of the safety feature in the target vehicle.

56. The method of claim 51, wherein the safety feature comprises one or more of lane keeping assist, blind spot information system, cross traffic alert, driver alert control, run-off road mitigation, collision avoidance assist, automatic emergency braking, electronic stability control, 360-degree camera system, and pilot assist.

57. The method of claim 51, the method further plans a behavior for the host vehicle in real-time, based on a confidence level on the target vehicle; and wherein the behavior of the host vehicle comprises one or more of maintaining a distance from the target vehicle, determining a maneuver path for the host vehicle, determining a coordinated movement with neighboring vehicles, determining an acceleration profile of the host vehicle, determining a speed profile of the host vehicle, and determining a lane change distances for the host vehicle.

58. A non-transitory computer-readable medium having stored thereon instructions executable by a computer system to perform operations comprising:
detecting, via a sensor of a host vehicle, a target vehicle;
capturing, via the sensor, a first region comprising a first characteristic of the target vehicle;
analyzing, the first region using an image processing module;
determining, an identity of the target vehicle;
capturing, via the sensor, a second region comprising a second characteristic of the target vehicle;
analyzing, the second region using the image processing module; and
determining, a safety feature that is enabled in the target vehicle; and
wherein the instructions configured for real-time identification of the safety feature in the target vehicle for adaptive behavior of the host vehicle.

59. The non-transitory computer-readable medium of claim 58, wherein the sensor comprises one or more of an image sensor, a light detection and ranging, a radio detection and ranging, an ultrasonic sensor, a microphone, and an infrared sensor.

60. The non-transitory computer-readable medium of claim 58, wherein the first characteristic comprises one or more of a logo, a registration plate, a tail lamp, a shape of the target vehicle, and a size of the target vehicle.

61. The non-transitory computer-readable medium of claim 58, wherein the identity comprises one or more of a brand, a model, and a make.
